(19) United States
(12) Patent Application Publication
(10) Pub. No.: US 2014/0178619 A1
(43) Pub. Date: Jun. 26, 2014

(54) ADHESIVE LAYER-EQUIPPED TRANSPARENT PLATE, DISPLAY DEVICE AND PROCESSES FOR THEIR PRODUCTION

(71) Applicant: Asahi Glass Company, Limited, Chiyoda-ku (JP)

(72) Inventors: Satoshi NIIYAMA, Chiyoda-ku (JP); Remi Kawakami, Chiyoda-ku (JP); Toyokazu Suzuki, Chiyoda-ku (JP); Naoko Aoki, Chiyoda-ku (JP)

(73) Assignee: Asahi Glass Company, Limited, Chiyoda-ku (JP)

(21) Appl. No.: 14/132,641

(22) Filed: Dec. 18, 2013

(30) Foreign Application Priority Data
Dec. 21, 2012 (JP) 2012-279440

(51) Int. Cl. B32B 3/02; B32B 37/10; B32B 38/10

(52) U.S. Cl. CPC B32B 3/02; B32B 38/10; B32B 37/1018
USPC 428/40.1; 428/192; 156/247; 156/285

(57) ABSTRACT

An adhesive layer-equipped transparent plate 1 comprising a transparent plate 10 and an adhesive layer 14 formed on one surface of the transparent plate 10, wherein the adhesive layer 14 has a layer portion 18 spreading over the surface of the transparent plate 10 and the seal portion 20 surrounding the periphery of the layer portion 18; and the layer portion 18 is made of a cured product of a layer portion-forming curable resin composition comprising a curable compound (II) containing a specific urethane acrylate oligomer (A), a monomer (B) and a monomer (C), and a non-curable oligomer (III) which does not undergo a curing reaction with the curable compound (II) at the time of curing and which has a hydroxy group.

### TECHNICAL FIELD

The present invention relates to an adhesive layer-equipped transparent plate, a display device having a display panel protected by the adhesive layer-equipped transparent plate, and processes for their production.

### BACKGROUND ART

As a display device having a display panel protected by a transparent plate (a protective plate), a display device having a display panel and an adhesive layer-equipped transparent plate having an adhesive layer formed on one surface of a transparent plate, bonded so that the adhesive layer is in contact with the display panel, is known. The adhesive layer of the adhesive layer-equipped transparent plate has a layer portion spreading over the surface of the transparent plate and a seal portion surrounding the periphery of the layer portion, and the layer portion is made of a cured product of a curable resin composition comprising a curable compound and a non-curable oligomer (Patent Documents 1 and 2).

To bond the display panel and the adhesive layer-equipped transparent plate, a method is known wherein the display panel and the adhesive layer-equipped transparent plate are bonded in a reduced pressure atmosphere, and then the laminate is returned to the atmospheric pressure atmosphere.

### PRIOR ART DOCUMENTS

### Patent Documents

Patent Document 1: WO2011/158839
Patent Document 2: WO2012/077726

### DISCLOSURE OF INVENTION

### Technical Problem

A display device having a display panel and an adhesive layer-equipped transparent plate united is generally used so that the display surface is set to be vertical. To evaluate the reliability assuming long-term use or use in high temperature environment, long-term storage tests at high temperature or at high temperature under high humidity are carried out (for example, at 60° C. or 80° C. for from 200 to 500 hours, in the case of consumer use, e.g. common TV monitor), and in a case where the adhesion at the interface between the display panel and the adhesive layer-equipped transparent plate is insufficient, there are problems in the reliability such that the display panel slips off or is separated from the adhesive layer-equipped transparent plate with time during long-term use at room temperature or use in high temperature environment.

The present invention is to provide an adhesive layer-equipped transparent plate using a curable resin composition such that, when bonded to an object to be bonded such as a display panel, voids are less likely to remain at the interface between the adhesive layer and the object, and sufficient adhesive force with the object is obtained even in high temperature environment at 60° C. or 80° C. or higher, and its production process. The present invention further provides a display device using the adhesive layer-equipped transparent plate, and its production process.

### Solution to Problem

The adhesive layer-equipped transparent plate of the present invention is an adhesive layer-equipped transparent plate comprising a transparent plate and an adhesive layer formed on at least one surface of the transparent plate, wherein the adhesive layer has a layer portion spreading over the surface of the transparent plate and a seal portion surrounding the periphery of the layer portion; and the layer portion is made of a cured product of a layer portion-forming curable resin composition comprising the following curable compound (II) and the following non-curable oligomer (III):

curable compound (II): a compound containing a urethane acrylate oligomer (A), a monomer (B) having one curable functional group and having a molecular weight less than 600, and a monomer (C) having at least two curable functional groups and having a molecular weight less than 900, provided that at least one member of the monomer (B) and the monomer (C) has a hydroxy group;

non-curable oligomer (III): an oligomer which does not undergo a curing reaction with the curable compound (II) at the time of curing the layer portion-forming curable resin composition and which has a hydroxy group.

It is preferred that the monomer (C) has an acryloyloxy group or a methacryloyloxy group.

It is preferred that the curable compound (II) has a composition comprising from 20 to 89 mass % of the urethane acrylate oligomer (A), from 10 to 79 mass % of the monomer (B) and from 0.1 to 10 mass % of the monomer (C) per 100 mass % of the total amount of the urethane acrylate oligomer (A), the monomer (B) and the monomer (C).

It is preferred that the monomer (B) contains a monomer (B1) which has a hydroxy group.

It is preferred that the monomer (B1) contains a hydroxy methacrylate which has a C₃₋₈ hydroxyalkyl group having from 1 to 2 hydroxy groups.

It is preferred that the urethane acrylate oligomer (A) has a number average molecular weight of from 1,000 to 100,000.

It is preferred that the non-curable oligomer (III) is a polyoxyalkylene polyol, and the urethane acrylate oligomer (A) is a urethane acrylate oligomer prepared from a polyoxyalkylene polyol and a polyisocyanate as raw materials.

It is preferred that of the layer portion, the value obtained by subtracting the loss tangent at 25° C. (tan δ (25° C.)) from the loss tangent at 80° C. (tan δ (80° C.)) is at most −0.05, and the storage shear modulus at 35° C. is at most 100 kPa.

It is preferred that the layer portion-forming curable resin composition does not contain a chain transfer agent, or contains a chain transfer agent in an amount of at most 1 part by mass per 100 parts by mass of the curable compound (II).

It is preferred that the layer portion-forming curable resin composition contains a photopolymerization initiator (D2).

It is preferred that the transparent plate is a protective plate for a display device.

It is preferred that the adhesive layer-equipped transparent plate of the present invention further has a removable protective film covering the surface of the adhesive layer.

The process for producing the adhesive layer-equipped transparent plate of the present invention comprises the following steps (a) to (e):

(a) a step of applying a liquid seal portion-forming curable resin composition to a peripheral portion of the surface of the transparent plate to form an uncured seal portion,

(b) a step of supplying a liquid layer portion-forming curable resin composition to a region surrounded by the uncured seal portion,

(c) a step of overlaying, in a reduced pressure atmosphere of at most 1 kPa, a protective film-bonded supporting plate on the layer portion-forming curable resin composition so that the protective film is in contact with the layer portion-forming curable resin composition, to obtain a laminate wherein an uncured layer portion made of the layer portion-forming curable resin composition, is sealed by the transparent plate, the protective film and the uncured seal portion,

(d) a step of curing the uncured layer portion and the uncured seal portion in a state where the laminate is held in an elevated pressure atmosphere of at least 50 kPa, to form an adhesive layer having a layer portion and a seal portion, and

(e) a step of removing the supporting plate from the protective film.

The display device of the present invention comprises a display panel and the adhesive layer-equipped transparent plate of the present invention, bonded to the display panel so that the adhesive layer is in contact with the display panel.

The process for producing the display device of the present invention comprises laminating and bonding, in a reduced pressure atmosphere of at most 100 Pa, the display panel and the adhesive layer-equipped transparent plate so that the adhesive layer is in contact with the display panel.

### Advantageous Effects of Invention

With the adhesive layer-equipped transparent plate of the present invention, when bonded to an object to be bonded, voids are less likely to remain at the interface between the adhesive layer and the object, and sufficient adhesive force with the object is obtained even in high temperature environment.

According to the process for producing an adhesive layer-equipped transparent plate of the present invention, it is possible to produce an adhesive layer-equipped transparent plate with which, when bonded to an object to be bonded, voids are less likely to remain at the interface between the adhesive layer and the object and sufficient adhesive force with the object is obtained even in high temperature environment.

The display device of the present invention is excellent in the reliability since formation of voids at the interface between the display panel and the adhesive layer is sufficiently prevented, and the display panel and the adhesive layer-equipped transparent plate are sufficiently bonded even in high temperature environment.

According to the process for producing a display device of the present invention, it is possible to produce a display device in which formation of voids at the interface between the display panel and the adhesive layer is sufficiently prevented, and the display panel and the adhesive layer-equipped transparent plate are sufficiently bonded even in high temperature environment.

### BRIEF DESCRIPTION OF DRAWINGS

FIG. 1 is a cross-sectional view illustrating an example of the adhesive layer-equipped transparent plate of the present invention.

FIG. 2 is a plan view illustrating an embodiment of the step (a).

FIG. 3 is a cross-sectional view illustrating an embodiment of the step (a).

FIG. 4 is a plan view illustrating an embodiment of the step (b).

FIG. 5 is a cross-sectional view illustrating an embodiment of the step (b).

FIG. 6 is a cross-sectional view illustrating an embodiment of the step (c).

FIG. 7 is a cross-sectional view illustrating an example of the display device of the present invention.

FIG. 8 is a perspective view illustrating a void at the interface between an adhesive layer and a display panel at the time when the display panel and the adhesive layer-equipped transparent plate of the present invention are bonded.

### DESCRIPTION OF EMBODIMENTS

In this specification, “transparent” means that after a plate and a display surface of a display panel are bonded via an adhesive layer without voids, the entire or a part of a display image on the display panel is visible through the plate without optical distortion. Accordingly, a plate can be regarded as “transparent” so long as a display image on a display panel is visible without optical distortion through the plate even if part of light which enters the plate from the display panel is absorbed or reflected by the plate, or even if the plate has a low visible light transmittance e.g. by a change in the optical phase.

Further, “curable functional group” means a functional group having a radical polymerizable unsaturated bond. Further, “(meth)acrylate” means an acrylate or a methacrylate.

### <<Adhesive Layer-Equipped Transparent Plate>>

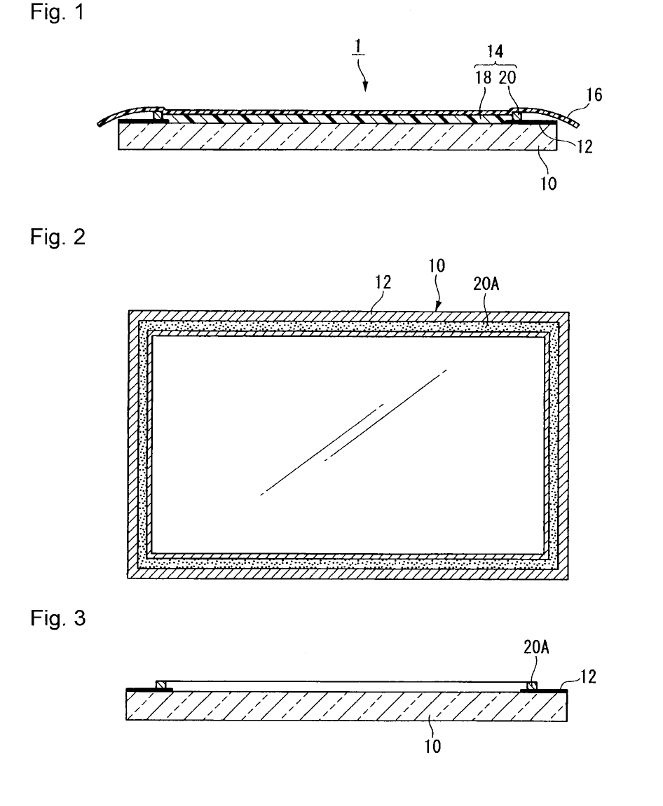

FIG. 1 is a cross sectional view illustrating an example of the adhesive layer-equipped transparent plate of the present invention.

An adhesive layer-equipped transparent plate 1 comprises a protective plate 10 (a protective plate), a light-shielding printed portion 12 formed at the peripheral portion of the surface of the transparent plate 10, an adhesive layer 14 formed on the surface of the transparent plate 10 on the side where the light-shielding printed portion 12 is formed, and a removable protective film 16 (protective material) covering the surface of the adhesive layer 14. The adhesive layer-equipped transparent plate 1 can be used to produce a display device by being bonded to a display panel after the protective film 16 is removed.

FIG. 1 illustrates a case where the adhesive layer 14 is formed on one surface of the transparent plate 10. However, the adhesive layer 14 may be formed on both surfaces of the transparent plate 10, and in such a case, the surface of each adhesive layer 14 is covered with the removable protective film 16.

### <Transparent Plate>

The transparent plate 10 is preferably a protective plate which is provided on the image display side of the after-mentioned display panel to protect the display panel.

The transparent plate 10 may be a glass plate or a transparent resin plate. The transparent plate 10 is most preferably a glass plate not only from such a viewpoint that the transparency is high to emitted light or reflected light from a display panel but also from such a viewpoint that it has light resistance, low birefringence, high planarity, surface-scratching resistance and high mechanical strength. The transparent plate 10 is preferably a glass plate also from such a viewpoint that it permits light to sufficiently pass therethrough to cure a photocurable resin composition.

As a material for the glass plate, a glass material such as soda lime glass may be mentioned. The glass plate is preferably made of less bluish highly transparent glass having a low iron content (white plate glass). In order to increase the safety, tempered glass may be used as a glass plate. Especially when a thin glass plate is to be used, it is preferred to employ a chemically tempered glass plate.

As a material of the transparent resin plate, a resin material having a high transparency (such as a polycarbonate or a polymethyl methacrylate) may be mentioned.

To the transparent plate 10, surface treatment may be applied in order to improve the interfacial adhesion to the adhesive layer 14. The method for such surface treatment may, for example, be a method of treating the surface of the transparent plate 10 with a silane coupling agent, or a method of forming a thin film of silicon oxide by an oxidation flame by means of a flame burner.

To the transparent plate 10, an antireflection layer may be provided on the surface opposite to the side having the adhesive layer 14 formed, in order to increase the contrast of a display image. To provide the antireflection layer, a method of directly forming an inorganic thin film on the surface of the transparent plate 10 or a method of bonding a transparent resin film provided with an antireflection layer, to the transparent plate 10 may, for example, be mentioned.

Further, depending upon the particular purpose, a part or whole of the transparent plate 10 may be colored, a part or whole of the surface of the transparent plate 10 may be made to have a frosted glass state to scatter light, or a part or whole of the surface of the transparent plate 10 may have fine irregularities, etc. formed to refract or reflect transmitted light. Otherwise, a colored film, a light scattering film, a photorefractive film, a light reflecting film, etc. may be bonded on part or whole of the surface of the transparent plate 10.

The shape of the protective plate 10 is usually rectangular so as to be fitted to the outer shape of the display device. Depending upon the outer shape of the display device, it is possible to use a curved outer shape covering the entire display surface of the display panel.

The size of the transparent plate 10 is properly set in accordance with the outer shape of the display panel.

The thickness of the transparent plate 10 is usually preferably from 0.5 to 25 mm in the case of a glass plate from the viewpoint of mechanical strength and transparency. In applications for television receivers, PC displays, etc. to be used indoors, the thickness is preferably from 1 to 6 mm with a view to reducing the weight of a display device, and in applications for public displays to be installed outdoors, it is preferably from 3 to 20 mm. In a case where chemically tempered glass is to be used, the thickness of the glass is preferably from about 0.5 to 1.5 mm from the viewpoint of the strength. In the case of a transparent resin plate, the thickness is preferably from 2 to 10 mm.

### <Light-Shielding Printed Portion>

The light-shielding printed portion 12 is one to shield wiring members, etc. connected to a display panel, so that other than the image display region of the after-mentioned display panel is not visible from the transparent plate 10 side. The light-shielding printed portion 12 may be formed on the surface of the side having the adhesive layer 14 formed or on the opposite side surface. With a view to reducing a parallax between the light-shielding printed portion 12 and the image display region, the light-shielding printed portion 12 is preferably formed on the surface of the side where the adhesive layer 14 is to be formed. In a case where the transparent plate 10 is a glass plate, it is preferred to use ceramic printing so that the light-shielding printed portion 12 contains a black pigment, whereby the light shielding property becomes high.

The light-shielding printed portion 12 may not be formed on the transparent plate 10 in a case where wiring members, etc. connected to a display panel are not visible from the side where the display panel is to be observed, a case where they are shielded by another member of a display device such as a housing, or a case where the adhesive layer-equipped transparent plate 1 is bonded to an object to be bonded other than the display panel.

### <Adhesive Layer>

The adhesive layer 14 has a layer portion 18 spreading over the surface of the transparent plate 10 and a seal portion 20 surrounding the periphery of the layer portion 18 in contact therewith.

The layer portion 18 is a portion made of a cured product (transparent resin) formed by curing the after-mentioned layer portion-forming curable resin composition (hereinafter sometimes referred to as “first composition”).

The seal portion 20 is a portion made of a cured product (transparent resin) formed by applying and curing a seal portion-forming curable resin composition (hereinafter sometimes referred to as “second composition”).

### [Seal Portion]

The second composition forming the seal portion 20 may be a photocurable resin composition or may be a thermosetting resin composition. The seal portion 20 is preferably made of a cured product of a photocurable resin composition comprising a curable compound and a photopolymerization initiator (D1), whereby curing at low temperature is possible and the curing speed is high. Further, when the second composition is a photocurable resin composition, since high temperature is not necessary for curing, the display panel is less likely to be damaged by the high temperature.

Otherwise, a second composition having the same composition as the first composition to be used for forming the layer portion may be applied to the peripheral portion of the surface of the transparent plate and semi-cured to form an uncured seal portion prior to being cured in the after-mentioned step (d).

Now, a photocurable second composition suitably used in the present invention, will be described. The photocurable second composition is a composition comprising a curable compound (I) which is photocurable and a photopolymerization initiator (D1).

Further, the second composition may contain an additive as the case requires.

The viscosity of the second composition at 25° C. is preferably from 500 to 3,000 Pa·s, more preferably from 800 to 2,500 Pa·s, further preferably from 1,000 to 2,000 Pa·s. When the viscosity of the second composition is at least 500 Pa·s, the shape of the uncured seal portion can be maintained for a relatively long period of time, and the height of the uncured seal portion can be sufficiently maintained. When the viscosity of the second composition is at most 3,000 Pa·s, the uncured seal portion can be formed by coating.

Further, even when the viscosity of the second composition forming the seal portion when applied is lower than 500 Pa·s, in a case where the second composition is a photocurable resin composition, it is irradiated with light immediately after coating whereby the viscosity of the second composition after irradiation with light is adjusted to be within the above preferred range. In view of coating easiness, the viscosity of the second composition when applied is preferably at most 500 Pa·s, more preferably at most 200 Pa·s.

The viscosity of the second composition is measured at 25° C. by means of an E-model viscometer.

Further, in order to maintain the distance between the transparent plate 10 and the display panel, spacer particles having a predetermined particle diameter may be incorporated to the second composition.

### (Curable Compound (I))

The curable compound (I) preferably comprises an oligomer (X) having a curable functional group and having Mn of from 30,000 to 100,000 and a monomer (Y) having at least one curable functional group and having a molecular weight of from 125 to 600, particularly preferably consists of the oligomer (X) and the monomer (Y), whereby the viscosity of the second composition is likely to be adjusted within the after-mentioned range.

Oligomer (X):

Mn of the oligomer (X) is from 30,000 to 100,000, preferably from 40,000 to 80,000, more preferably from 50,000 to 65,000. When Mn of the oligomer (X) is within such a range, the viscosity of the second composition can easily be adjusted to be within the after-mentioned range.

Mn of the oligomer (X) is Mn as calculated as polystyrene, obtained by the measurement by GPC (gel permeation chromatography). Here, in the measurement by GPC, in a case where a peak of the unreacted low molecular weight component (such as a monomer) appears, Mn is obtained by excluding such a peak.

The curable functional group of the oligomer (X) may, for example, be an acryloyloxy group or a methacryloyloxy group, and is preferably a group selected from an acryloyloxy group and a methacryloyloxy group, whereby the curing speed is high, and a highly transparent seal portion can be obtained.

The average number of the curable functional groups per one molecule of the oligomer (X) is preferably from 1.8 to 4, from the viewpoint of the curing property of the second composition and the mechanical properties of the seal portion.

The oligomer (X) may, for example, be a urethane oligomer having a urethane bond, a poly(meth)acrylate of a polyoxyalkylene polyol, or a poly(meth)acrylate of a polyester polyol.

One type of the oligomer (X) may be used, or two or more types may be used.

From such a viewpoint that the mechanical properties of the resin after curing, the adhesion with a plate, etc. can widely be adjusted by the molecular weight design of the urethane chain, etc., the oligomer (X) is preferably a urethane oligomer prepared from a polyol and a polyisocyanate as raw materials, more preferably the after-mentioned urethane oligomer (x1). As the polyol, a polyoxyalkylene polyol is preferred.

The oligomer (X1) is a urethane oligomer prepared in such a manner that a polyol and a polyisocyanate are reacted in the presence of the following monomer (x2) used as a diluting agent, to obtain a prepolymer having an isocyanate group at its terminal, and the following monomer (x1) is reacted with the isocyanate group of the prepolymer.

Monomer (x1): a monomer having a molecular weight of from 125 to 600, having at least one curable functional group, and having a group reactive with an isocyanate group.

Monomer (x2): a monomer having a molecular weight of from 125 to 600, having at least one curable functional group and having no group reactive with an isocyanate group.

The monomer (x1) may be a monomer having a group having active hydrogen (such as a hydroxy group or an amino group) and a curable functional group.

The monomer (x1) may, for example, be specifically a hydroxyalkyl (meth)acrylate having a C₂₋₆ hydroxyalkyl group (such as 2-hydroxyethyl (meth)acrylate, 2-hydroxypropyl (meth)acrylate, 2-hydroxybutyl (meth)acrylate or 4-hydroxybutyl (meth)acrylate).

The monomer (x1) to be reacted with the prepolymer is preferably a hydroxyalkyl acrylate having a C₂₋₄ hydroxyalkyl group.

The monomer (x2) may, for example, be an alkyl (meth)acrylate having a C₈₋₂₂ alkyl group (such as n-dodecyl (meth)acrylate, n-octadecyl (meth)acrylate or n-behenyl (meth)acrylate) or a (meth)acrylate having an alicyclic hydrocarbon group (such as isobornyl (meth)acrylate or adamantyl (meth)acrylate).

The oligomer (X1) having Mn of from 30,000 to 100,000 can hardly be prepared by a conventional method due to its high viscosity, and even if it can be prepared, it can hardly be mixed with the monomer (Y).

Accordingly, it is preferred to prepare the oligomer (X1) by a preparation method using the monomer (x1) and (x2), and to use the obtained product as it is for the second composition, or to use the obtained product for the second composition after diluted with the monomer (x2) or the like.

As the polyol and the polyisocyanate, known compounds may be used, such as the polyol (i) and the diisocyanate (ii), disclosed as raw materials for a urethane type oligomer (a) in WO2009/016943.

The polyol may, for example, be specifically a polyoxyalkylene polyol (such as polyoxyethylene glycol or polyoxypropylene polyol), a polyester polyol or a polycarbonate polyol. Among them, the polyol is preferably a polyoxyalkylene polyol, more preferably polyoxypropylene polyol. Further, polyoxyethylene polyoxypropylene polyol having oxypropylene groups and oxyethylene groups is more preferred, whereby the compatibility with other components of the second composition can be increased.

The polyols may be used alone or in combination of two or more.

The polyisocyanate is preferably at least one diisocyanate selected from the group consisting of an aliphatic diisocyanate, an alicyclic diisocyanate and non-yellowing aromatic diisocyanate.

The aliphatic polyisocyanate may, for example, be hexamethylene diisocyanate, 2,2,4-trimethyl-hexamethylene diisocyanate or 2,4,4-trimethyl-hexamethylene diisocyanate.

The alicyclic polyisocyanate may, for example, be isophorone diisocyanate or methylenebis(4-cyclohexyl isocyanate).

The non-yellowing aromatic diisocyanate may, for example, be xylylene diisocyanate.

The polyisocyanates may be used alone or in a combination of two or more.

Monomer (Y):

The molecular weight of the monomer (Y) is from 125 to 600, preferably from 140 to 400, more preferably from 150 to 350. When the molecular weight of the monomer (Y) is at least 125, volatilization of the monomer (Y) can be prevented at the time of producing a display device by the after-mentioned reduced pressure lamination method. When the molecular weight of the monomer (Y) is at most 600, it is possible to increase the solubility of the monomer (Y) in the high molecular weight oligomer (X) and it is possible to suitably carry out the viscosity adjustment as the second composition.

The curable functional group of the monomer (Y) may, for example, be an acryloyloxy group or a methacryloyloxy group, and is preferably a group selected from an acryloyloxy group and a methacryloyloxy group, whereby the curing speed is high, and a highly transparent seal portion will be obtained.

The curable functional group in the oligomer (X) and the curable functional group in the monomer (Y) may be the same or different from each other. The curable functional group in the oligomer (X) having a relatively high molecular weight tends to have a lower reactivity than the curable functional group in the monomer (Y) having a relatively low molecular weight. Accordingly, curing of the monomer (Y) is likely to advance, whereby the viscosity of the entire composition is likely to be increased rapidly, and the curing reaction tends to be non-uniform. In order to minimize the difference in the reactivity of the curable functional groups of both and to obtain a homogeneous seal portion, it is more preferred that the curable functional group of the oligomer (X) is an acryloyloxy group having a relatively high reactivity, and the curable functional group of the monomer (Y) is a methacryloyloxy group having a relatively low reactivity.

The number of the curable functional group per one molecule of the monomer (Y) is preferably from 1 to 3 from the viewpoint of the curing property of the second composition and the mechanical properties of the seal portion.

The monomer (Y) may, for example, be the same monomer mentioned for the monomer (x1) and the monomer (x2).

The monomer (Y) preferably contains a monomer (Y1) having a curable functional group and having a hydroxy group from the viewpoint of the adhesion between the transparent plate and the seal portion or the solubility of the after-mentioned various additives.

As the monomer (Y1), a hydroxy methacrylate which has a C₃₋₈ hydroxyalkyl group having from 1 to 2 hydroxy groups (such as 2-hydroxypropyl methacrylate, 2-hydroxybutyl methacrylate, 4-hydroxybutyl methacrylate or 6-hydroxyhexyl methacrylate) is preferred, and 2-hydroxybutyl methacrylate is particularly preferred.

The proportion of the monomer (Y) in the second composition is preferably from 10 to 90 mass %, more preferably from 20 to 70 mass %, to the total amount (100 mass %) of the oligomer (X) and the monomer (Y). When the proportion of the monomer (Y) is at least 10 mass %, the curing property of the second composition and the adhesion between the transparent plate and the seal portion will be good. When the proportion of the monomer (Y) is at most 90 mass %, the viscosity of the second composition can easily be adjusted to be at least 500 Pa·s.

Further, in preparation of the oligomer (X1), the monomer (x1) reacted with the isocyanate group of the prepolymer is present as a part of the oligomer (X) and therefore is not included in the proportion of the monomer (Y) in the second composition. On the other hand, the monomer (x2) used as a diluting agent in preparation of the oligomer (X1) and the monomer (x1) and the monomer (x2) used as a diluting agent after preparation of the oligomer (X1) are included in the proportion of the monomer (Y) in the second composition.

### (Photopolymerization Initiator (D1))

As the photopolymerization initiator (D1) to be contained in the photocurable second composition, a photopolymerization initiator of e.g. acetophenone type, ketal type, benzoin or benzoin ether type, phosphine oxide type, benzophenone type, thioxanthone type or quinone type may be mentioned, and a photopolymerization initiator of acetophenone type, ketal type or benzoin ether type is preferred as the photopolymerization initiator (D1). In a case where curing is carried out by means of a short wavelength visible light, a photopolymerization initiator of phosphine oxide type is more preferred from the viewpoint of the absorption wavelength region. By using two or more photopolymerization initiators (D1) different in the absorption wavelength region in combination, it is possible to further accelerate the curing time or to increase the surface hardness at the seal portion.

The content of the photopolymerization initiator (D1) in the photocurable second composition is preferably from 0.01 to 10 parts by mass, more preferably from 0.1 to 5 parts by mass, per 100 parts by mass of the total amount of the oligomer (X) and the monomer (Y).

### (Additives)

The additives may, for example, be a polymerization inhibitor, a photo-curing accelerator, a chain transfer agent, a light stabilizer (such as an ultraviolet absorber or a radical scavenger), an antioxidant, a flame retardant, an adhesion-improving agent (such as a silane coupling agent), a pigment or a dye. Preferred is a polymerization inhibitor or a light stabilizer. Particularly, when a polymerization inhibitor is contained in an amount smaller than the polymerization initiator, it is possible to improve the storage stability of the second composition and to adjust the molecular weight of the seal portion after curing.

As the polymerization inhibitor, a polymerization inhibitor of e.g. hydroquinone type (such as 2,5-di-tert-butylhydroquinone), catechol type (such as p-tert-butylcatechol), anthraquinone type, phenothiazine type or hydroxy toluene type may be mentioned.

As the light stabilizer, an ultraviolet absorber (such as benzotriazole type, benzophenone type or salicylate type) or a radical scavenger (such as hindered amine type) may, for example, be mentioned.

As the antioxidant, a phosphorus type or sulfur type compound may, for example be mentioned.

The total amount of such additives is preferably at most 10 parts by mass, more preferably at most 5 parts by mass, per 100 parts by mass of the total amount of the oligomer (X) and the monomer (Y).

As the region outside of the image display region of a display panel is relatively narrow, the width of the seal portion 20 is preferably made narrow. The width of the seal portion 20 is preferably from 0.5 to 2 mm, more preferably from 0.5 to 1.6 mm.

The storage shear modulus of the seal portion 20 at 35° C. is preferably higher than the storage shear modulus of the layer portion 18 at 35° C. When the storage shear modulus of the seal portion 20 preferably higher than the storage shear modulus of the layer portion 18, at the time when the display panel and the adhesive layer-equipped plate 1 are bonded, even if voids remain at the interface between the display panel and the adhesive layer 14 at the peripheral portion of the adhesive layer 14, the voids are less likely to be open to exterior and is likely to become independent voids. Accordingly, when, after bonding the display panel and the adhesive layer-equipped transparent plate 1 in a reduced pressure atmosphere, the laminate is returned to the atmospheric pressure atmosphere, the volume of the voids will decrease, and the voids will eventually disappear, by the differential pressure between the pressure in the voids (the reduced pressure) and the pressure exerted to the adhesive layer 14 (the atmospheric pressure).

The thickness of the seal portion 20 is preferably slightly more than the thickness of the layer portion 18, whereby voids open to exterior are less likely to form when the display panel and the adhesive layer-equipped transparent plate are bonded.

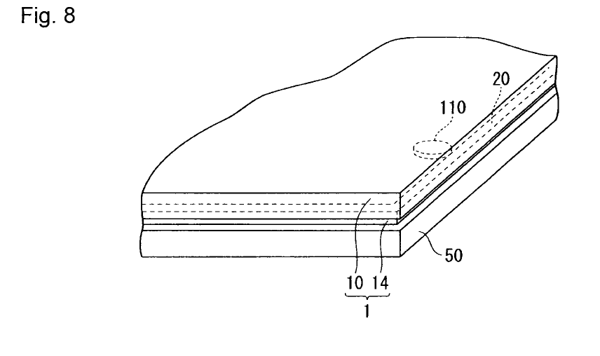

When the thickness of the seal portion 20 is more than the thickness of the layer portion 18, at the time when the display panel 50 and the adhesive layer-equipped transparent plate 1 are bonded as shown in FIG. 8, even if a void 110 remains at the interface between the display panel 50 and the adhesive layer 14 at the peripheral portion of the adhesive layer 14, the void 110 is shielded by the seal portion 20, whereby the void 110 is not open to exterior and becomes an independent void 110. Accordingly, when, after bonding the display panel 50 and the adhesive layer-equipped transparent plate 1 in a reduced pressure atmosphere, the laminate is returned to the atmospheric pressure atmosphere, the volume of the void 110 will decrease, and the void 110 will eventually disappear, by the differential pressure between the pressure in the void 110 (the reduced pressure) and the pressure exerted to the adhesive layer 14 (the atmospheric pressure).

The difference between the thickness of the seal portion 20 and the thickness of the layer portion 18 is preferably at most 0.05 mm, more preferably at most 0.03 mm, in order to prevent formation of voids due to a difference in level between the seal portion 20 and the layer portion 18.

The difference between the thickness of the seal portion 20 and the thickness of the layer portion 18 is obtained from the difference between the total thickness of the transparent plate 10 and the layer portion 18 formed thereon, and the total thickness of the transparent plate 10 and the seal portion 20 formed thereon, measured by a laser displacement meter. Further, the thickness of the layer portion 18 is the thickness of the peripheral portion of the layer portion 18 in contact with the seal portion 20.

### [Layer Portion]

The first composition forming the layer portion 18 may be a photocurable resin composition or may be a thermosetting resin composition. The layer portion 18 is preferably made of a cured product of a photocurable resin composition, whereby curing at low temperature is possible, and the curing speed is high. Further, when the first composition is a photocurable resin composition, since high temperature is unnecessary for curing, the display panel is less likely to be damaged by the high temperature.

Now, a photocurable first composition suitable in the present invention will be described. The photocurable first composition is a composition comprising a curable compound (II), a non-curable oligomer (III) and a photopolymerization initiator (D2). The non-curable oligomer (III) is an oligomer which does not undergo a curing reaction with the curable compound (II) in the composition at the time of curing the first composition and which has a hydroxy group.

Further, the first composition may contain additives as the case requires.

The viscosity of the first composition is preferably from 0.05 to 50 Pa·s, more preferably from 1 to 20 Pa·s. When the viscosity of the first composition is at least 0.05 Pa·s, it is possible to suppress the proportion of the monomer (B) and the monomer (C), and thereby to prevent deterioration of the physical properties of the layer portion 18. Further, the low boiling point component decreases, such being advantageous for the after-mentioned reduced pressure lamination method. When the viscosity of the first composition is at most 50 Pa·s, voids are less likely to remain in the layer portion 18.

The viscosity of the first composition is measured at 25° C. by means of an E-model viscometer.

### (Curable Compound (II))

The curable compound (II) comprises a urethane acrylate oligomer (A) (hereinafter referred to simply as “oligomer (A)”), a monomer (B) having one curable functional group having a molecular weight less than 600, and a monomer (C) having at least two curable functional groups and having a molecular weight less than 900. The curable compound (II) preferably consists of the oligomer (A), the monomer (B) and the monomer (C).

At least one member of the monomer (B) and the monomer (C) has a hydroxy group. In the layer portion made of a cured product of the first composition, such hydroxy groups remain. Presence of such hydroxy groups contributes to dispersion stability of the non-curable oligomer (III) in the layer portion.

Oligomer (A):

Mn of the oligomer (A) is preferably from 1,000 to 100,000, more preferably from 10,000 to 70,000. When Mn of the oligomer (A) is within such a range, the viscosity of the first composition can easily be adjusted to be within the above range.

Mn of the oligomer (A) is Mn as calculated as polystyrene, obtained by the measurement by GPC. In the measurement by GPC, in a case where a peak of an unreacted low molecular weight component (such as a monomer) appears, Mn is obtained by excluding such a peak.

The oligomer (A) preferably has an acryloyloxy group.

The average number of acryloyloxy groups per one molecule of the oligomer (A) is preferably from 1.8 to 4 from the viewpoint of the curing property of the first composition and the mechanical properties of the layer portion.

On type of the oligomer (A) may be used, or two or more types may be used.

The oligomer (A) is preferably the following polyurethane acrylate oligomer (A1) (hereinafter referred to as “oligomer (A1)”).

Oligomer (A1): a polyurethane acrylate oligomer obtained in such a manner that a polyol and a polyisocyanate are reacted to obtain a prepolymer having an isocyanate group at its terminal, and the following monomer (a1) is reacted with the isocyanate group of the prepolymer.

Monomer (a1): a monomer having a molecular weight of from 125 to 600, having at least one acryloyloxy group and having a group reactive with an isocyanate group.

The monomer (a1) may be a monomer having a group having active hydrogen (such as a hydroxy group or an amino group) and an acryloyloxy group.

The monomer (a1) may, for example, be specifically a hydroxyalkyl acrylate having a C₂₋₆ hydroxyalkyl group (such as 2-hydroxyethyl acrylate, 2-hydroxypropyl acrylate, 2-hydroxybutyl acrylate or 4-hydroxybutyl acrylate).

The monomer (a1) reactive with the prepolymer is preferably a hydroxyalkyl acrylate having a C₂₋₄ hydroxyalkyl group.

The polyol and the polyisocyanate may be the same as in the case of the oligomer (X1).

The polyol is preferably a polyoxyalkylene polyol, more preferably polyoxypropylene polyol. Further, more preferred is polyoxyethylene polyoxypropylene polyol having oxypropylene groups and oxyethylene groups, whereby the compatibility with other components of the first composition can be increased.

The polyisocyanate is preferably at least one diisocyanate selected from the group consisting of an aliphatic diisocyanate, an alicyclic diisocyanate and a non-yellowing aromatic diisocyanate.

For preparation of the oligomer (A1), the same monomer as the monomer (x2) mentioned for the oligomer (X1) may be used as a diluting agent.

Monomer (B):

The molecular weight of the monomer (B) is less than 600, preferably at least 125 and less than 600, more preferably from 140 to 400. The lower the molecular weight of the monomer (B), the better the adhesion between the transparent plate and the layer portion. When the molecular weight of the monomer (B) is at least the lower limit value, volatilization of the monomer (B) can be prevented at the time of producing a display device by the after-mentioned reduced pressure lamination method.

One type of the monomer (B) may be used, or two or more types may be used.

The number of the curable functional group per one molecule of the monomer (B) is one.

The curable functional group of the monomer (B) may, for example, be an acryloyl group, a methacryloyl group, an acryloyloxy group or a methacryloyloxy group. The curable functional group of the monomer (B) is preferably a group selected from an acryloyloxy group and a methacryloyloxy group, whereby the curing speed is high and a highly transparent layer portion will be obtained, and is particularly preferably a methacryloyloxy group, whereby the difference in the reactivity of the curable functional groups between the oligomer (A) and the monomer (B) tends to be small, and a homogeneous layer portion can be obtained.

The monomer (B) preferably contains the following monomer (B1). The monomer (B1) contributes to dispersion stability of the non-curable oligomer (III). Further, when the monomer (B1) is contained, favorable adhesion between the transparent plate and the layer portion is likely to be obtained.

Monomer (B1): a monomer having a molecular weight less than 600, having one curable functional group and having a hydroxy group.

The number of hydroxy groups which the monomer (B1) has is preferably 1 or 2.

The monomer (B1) having one hydroxy group may, for example, be 2-hydroxyethyl (meth)acrylate, 2-hydroxypropyl (meth)acrylate, 2-hydroxybutyl (meth)acrylate or 4-hydroxybutyl (meth)acrylate.

The monomer (B1) having two hydroxy groups may, for example, be glycerin monomethacrylate or 2,3-dihydroxypropyl acrylate.

The monomer (B1) is preferably a hydroxy methacrylate which has a C₃₋₈ hydroxyalkyl group having from 1 to 2 hydroxy groups (such as 2-hydroxypropyl methacrylate, 2-hydroxybutyl methacrylate or 4-hydroxybutyl methacrylate), particularly preferably 2-hydroxybutyl methacrylate.

One type of the monomer (B1) may be used, or two or more types may be used.

Further, as the monomer (B), the following monomer (B2) may also be mentioned.

Monomer (B2): a monomer having one curable functional group, having a molecular weight less than 600 and having no hydroxy group.

As the monomer (B2), the following monomer (B21) is preferably contained. When the monomer (B21) is contained, the time required for curing the first composition tends to be long.

Monomer (B21): an alkyl methacrylate having no hydroxy group and having a C₈₋₂₂ alkyl group.

The monomer (B21) may, for example, be n-dodecyl methacrylate, n-octadecyl methacrylate or n-behenyl methacrylate, and is preferably n-dodecyl methacrylate or n-octadecyl methacrylate.

One type of the monomer (B2) may be used, or two or more types may be used.

Monomer (C):

The molecular weight of the monomer (C) is less than 900, preferably at least 125 and less than 900, more preferably from 140 to 600. The lower the molecular weight of the monomer (C), the more the resin elastic modulus of the layer portion after curing can easily be controlled to be within a preferred range, and the better the adhesion with an object to be bonded even in high temperature environment. When the molecular weight of the monomer (C) is at least 125, volatilization of the monomer (C) can be prevented at the time of producing a display device by the after-mentioned reduced pressure lamination method. If the molecular weight of the monomer (C) is at least 900, an effect to suppress the flowability of the layer portion in high temperature environment tends to be low per addition amount, the adhesion with an object to be bonded may not be maintained, and the reliability tends to be deteriorated, i.e. separation or displacement may occur.

One type of the monomer (C) may be used, or two or more types may be used.

By the curable compound (II) constituting the first composition containing the monomer (C), the layer portion is crosslinked, and sufficient adhesion to an object to be bonded can be maintained even in high temperature environment.

The curable functional group of the monomer (C) may, for example, be an acryloyl group, a methacryloyl group, an acryloyloxy group or a methacryloyloxy group. The curable functional group of the monomer (C) is preferably a group selected from an acryloyloxy group and a methacryloyloxy group, whereby the curing speed is high and a highly transparent layer portion will be obtained, and is particularly preferably a methacryloyloxy group, whereby the difference in the reactivity of the curable functional groups between the oligomer (A) and the monomer (C) tends to be small, whereby a homogeneous layer portion will be obtained. The number of curable functional groups per one molecule of the monomer (C) is at least 2, and is preferably from 2 to 4 from the viewpoint of the curing property of the first composition and the mechanical properties of the layer portion.

The monomer (C) is classified into the following monomers (C1) and (C2).

Monomer (C1): a monomer having at least two curable functional groups, having a molecular weight less than 900 and having a hydroxy group.

Monomer (C2): a monomer having at least 2 curable functional groups, having a molecular weight less than 900 and having no hydroxy group.

The number of hydroxy groups which the monomer (C1) has is preferably 1 or 2.

The monomer (C1) may, for example, be an ester compound of a compound having at least 3 hydroxy groups and (meth)acrylic acid in a smaller number of moles than the number of moles of hydroxy groups. The compound having at least 3 hydroxy groups may, for example, be glycerin, trimethylolpropane or pentaerythritol, and the ester compound of such a compound and (meth)acrylic acid may, for example, be glycerin dimethacrylate or 2-hydroxy-3-acryloyloxypropyl methacrylate.

The monomer (C2) may, for example, be an ester compound of a compound having at least 2 hydroxy groups and (meth)acrylic acid in a smaller number of moles than the number of moles of the hydroxy groups. The compound having at least 2 hydroxy groups may, for example, be ethylene glycol, 1,4-butanediol, dipropylene glycol, 1,9-nonanediol, glycerin, trimethylolpropane or pentaerythritol, and the ester compound of such a compound and (meth)acrylic acid may, for example, be 1,9-nonanediol dimethacrylate, ethoxylated (3) trimethylolpropane triacrylate or glycerin propoxytriacrylate.

In the curable compound (II), at least one member of the monomer (B) and the monomer (C) has a hydroxy group. The curable compound (II) preferably contains the monomer (B) in a larger amount than the monomer (C), whereby the shear modulus after the first composition is cured is set to be within the after-mentioned range.

The content of the curable compound (II) in the first composition (100 mass %) is preferably from 10 to 90 mass %, more preferably from 20 to 70 mass %. When the content of the curable compound (II) is at least 10 mass %, sufficient adhesive force between the adhesive layer-equipped transparent plate and an object to be bonded will be obtained even at high temperature, and high reliability will be obtained. When the content of the curable compound (II) is at most 90 mass %, voids are less likely to remain at the interface between the adhesive layer and an object to be bonded.

The proportion of the oligomer (A) to the total amount (100 mass %) of the oligomer (A), the monomer (B) and the monomer (C) is preferably from 20 to 89 mass %, more preferably from 30 to 80 mass %. When the proportion of the oligomer (A) is at least 20 mass %, the layer portion will have favorable heat resistance. When the proportion of the oligomer (A) is at most 89 mass %, favorable curing property of the first composition and adhesion between the transparent plate and the layer portion will be obtained.

The proportion of the monomer (B) to the total amount (100 mass %) of the oligomer (A), the monomer (B) and the monomer (C) is preferably from 10 to 79 mass %, more preferably from 20 to 70 mass %.

The proportion of the monomer (B1) to the total amount (100 mass %) of the oligomer (A), the monomer (B) and the monomer (C) is preferably from 10 to 60 mass %, more preferably from 20 to 50 mass %. When the proportion of the monomer (B1) is at least 10 mass %, favorable storage stability of the first composition and adhesion between the transparent plate and the layer portion will be obtained.

The proportion of the monomer (B2) to the total amount (100 mass %) of the oligomer (A), the monomer (B) and the monomer (C) is preferably from 10 to 50 mass %, more preferably from 20 to 40 mass %. If the proportion of the monomer (B2) is higher than the monomer (B1) by the mass ratio, at the time when the adhesive layer-equipped transparent plate and an object to be bonded are bonded in a reduced pressure atmosphere and then the laminate is returned to an atmospheric pressure, the time until voids formed at the interface have them disappear, tends to be long. On the other hand, when the monomer (B2) is contained, the time required for curing of the layer portion-forming photocurable resin composition tends to be long.

The proportion of the monomer (C) to the total amount (100 mass %) of the oligomer (A), the monomer (B) and the monomer (C) is preferably from 0.1 to 10 mass %, more preferably from 0.5 to 5 mass %. Here, the proportion of the monomer (C) is an appropriate proportion within the above range, in balance with the elastic modulus and the reliability. The higher the molecular weight of the monomer (C), the smaller the number of the curable functional groups in the first composition, and accordingly the proportion of the monomer (C) in the first composition is preferably higher.

The proportion of the monomer (B) and the monomer (C) in total to the total amount (100 mass %) of the oligomer (A), the monomer (B) and the monomer (C) is preferably from 10 to 80 mass %, more preferably from 20 to 70 mass %.

The first composition preferably has a composition comprising from 20 to 89 mass % of the oligomer (A), from 10 to 79 mass % of the monomer (B) and from 0.1 to 10 mass % of the monomer (C) per 100 mass % of the total amount of the oligomer (A), the monomer (B) and the monomer (C).

In a case where the monomer (B) is the monomer (B1), the first composition preferably comprises from 20 to 89 mass % of the oligomer (A), from 10 to 60 mass % of the monomer (B1) and from 0.1 to 10 mass % of the monomer (C) per 100 mass % of the total amount of the oligomer (A), the monomer (B) and the monomer (C).

In a case where the monomer (B) is the monomer (B2), the first composition preferably comprises from 20 to 89 mass % of the oligomer (A), from 10 to 50 mass % of the monomer (B2) and from 0.1 to 10 mass % of the monomer (C) per 100 mass % of the total amount of the oligomer (A), the monomer (B2) and the monomer (C).

Further, in preparation of the oligomer (A1), the monomer (a1) reacted with the isocyanate group of the prepolymer is present as a part of the oligomer (A) and therefore is not included in the proportion of the monomer (B) and the monomer (C) in the first composition. On the other hand, in a case where the monomer (which is not reactive with the prepolymer) to be added at the time of preparation or as a diluting agent after preparation of the oligomer (A1) corresponds to the monomer (B) or the monomer (C), such a monomer is included in the proportion of the monomer (B) or the monomer (C) in the first composition.

### (Non-Curable Oligomer (III))

The non-curable oligomer (III) is an oligomer which does not undergo a curing reaction with the curable compound (II) in the composition at the time of curing the first composition and which has a hydroxy group.

The average number of hydroxy groups per one molecule of the non-curable oligomer (III) is preferably from 0.8 to 3, more preferably from 1.8 to 2.3.

Mn per one hydroxy group of the non-curable oligomer (III) is preferably from 400 to 8,000. When Mn per one hydroxy group is at least 400, the polarity of the non-curable oligomer (III) will not be too high, and good compatibility with the curable compound (II) in the first composition is readily obtainable. When Mn per one hydroxy group is at most 8,000, it is readily possible to obtain the effect of dispersion stabilization of the non-curable oligomer (III) in the layer portion after curing by an interaction between the hydroxy group derived from the curable compound (II) and the hydroxy group of the non-curable oligomer (III). It is considered that a hydrogen bond contributes to such an interaction.

Such non-curable oligomers (III) may be used alone or in combination of two or more.

The non-curable oligomer may, for example, be a high molecular weight polyol. The non-curable oligomer (III) is preferably a polyoxyalkylene polyol, a polyester polyol or a polycarbonate polyol.

The polyoxyalkylene polyol may, for example, be a polyoxyalkylene diol such as polyoxyethylene glycol, polyoxypropylene diol, polyoxypropylene triol or polyoxytetramethylene glycol.

Mn per one hydroxy group of the polyoxyalkylene polyol is preferably from 400 to 8,000, more preferably from 600 to 5,000.

The polyester polyol may be an aliphatic polyester diol having a residue of an aliphatic diol (such as ethylene glycol, propylene glycol or 1,4-butanediol) and a residue of an aliphatic dicarboxylic acid (such as glutaric acid, adipic acid or sebacic acid).

Mn per one hydroxy group of the polyester polyol is preferably from 400 to 8,000, more preferably from 800 to 6,000.

The polycarbonate polyol may, for example, be an aliphatic polycarbonate diol having a residue of a diol (such as 1,6-hexanediol), or an aliphatic polycarbonate diol such as a ring-opened polymer of an alicyclic carbonate.

Mn per one hydroxy group of the polycarbonate polyol is preferably from 400 to 8,000, more preferably from 800 to 6,000.

In this specification, Mn of the non-curable oligomer (III) is a value calculated by the following formula (I) from the hydroxy value P (mgKOH/g) measured in accordance with JIS K1557-1 (2007 edition) and the average number Q of hydroxy groups per one molecule of the non-curable oligomer (III).

Molecular weight of non-curable oligomer (III)=56.1×Q×1,000/P (1)

From such a viewpoint that the elastic modulus of the layer portion after curing can easily be made lower, it is preferred to use, as the non-curable oligomer (III), a polyoxyalkylene polyol, and polyoxypropylene polyol is particularly preferred. Further, polyoxyethylene polyoxypropylene polyol having oxypropylene groups and oxyethylene groups may be used as the non-curable oligomer (III).

In the present invention, in order to stabilize the layer portion before curing and to prevent separation of the non-curable oligomer (III) from the layer portion after curing, it is preferred that the oligomer (A) and the non-curable oligomer (III) have molecular chains having the same or similar structures.

Specifically, it is preferred not only to use a compound having a hydroxy group (hereinafter sometimes referred to as a hydroxy group-containing compound) as a raw material of the oligomer (A) in the first composition, but also to use the same hydroxy group-containing compound as the non-curable oligomer (III).

In the present invention, it is particularly preferred that the oligomer (A) is a urethane acrylate oligomer prepared from a polyoxyalkylene polyol and a polyisocyanate as raw materials, and that the non-curable oligomer (III) is a polyoxyalkylene polyol.

Even in a case where the hydroxy group-containing compound as a raw material for the oligomer (A) and the hydroxy group-containing compound to be used as the non-curable oligomer (III) are not the same, it is preferred that the molecular chains of both have partially common structures such as common repeating units, and the polarities of both are made to be substantially equal. The compatibility of the non-curable oligomer (III) in the composition will be more increased when the oligomer (A) and the non-curable oligomer (III) have the same molecular structure even though partially.

The method for adjusting the polarity of the hydroxy group-containing compound may, for example, be a method of introducing a polar group, or a method of using a hydroxy group-containing compound having an oxypropylene group and an oxyethylene group. By introduction of a polar group, the polarity of the hydroxy group-containing compound will be increased. Further, by use of a hydroxy group-containing compound having an oxypropylene group and an oxyethylene group, the polarity will be increased as compared with a hydroxy group-containing compound having only an oxypropylene group. A combination of these methods may also be used.

In a case where the hydroxy group-containing compound used as a raw material for the oligomer (A) and the hydroxy group-containing compound used as the non-curable oligomer (III) are not the same, as a preferred combination, the following combination may be mentioned.

A combination such that the oligomer (A) is a urethane acrylate oligomer prepared from polyoxyethylene polyoxypropylene polyol having oxypropylene groups and oxyethylene groups, and a polyisocyanate as raw materials, and the non-curable oligomer (III) is a polyoxypropylene polyol having no oxyethylene group, and having a molecular weight per one hydroxy group lower than that of the polyol to be used as the oligomer (A).

As a combination of the curable compound (II) and the non-curable oligomer (III) contained in the first composition, most preferred is a combination of a curable compound (II-1) comprising the following oligomer (A12), the monomer (B1) and the monomer (C1), and the following non-curable oligomer (III-1).

Oligomer (A12): a polyurethane acrylate oligomer obtained in such a manner that polyoxyethylene polyoxypropylene diol having oxypropylene groups and oxyethylene groups and a polyisocyanate are reacted to obtain a prepolymer having an isocyanate group at its terminal, which is reacted with the above monomer (a1).

Non-curable oligomer (III-1): polyoxyethylene polyoxypropylene diol having oxypropylene groups and oxyethylene groups, which is the same as the raw material for the oligomer (A12).

Further, as the combination of the curable compound (II) and the non-curable oligomer (III) contained in the first composition, a combination of the curable compound (II-1) comprising the oligomer (A12), the monomer (B1) and the monomer (C1), and the following non-curable oligomer (III-2) is also preferred.

Non-curable oligomer (III-2): polyoxypropylene diol having only oxypropylene groups, having a molecular weight lower than the polyoxypropylene diol as the raw material for the oligomer (A12).

The non-curable oligomer (III) in the first composition contributes to, at the time when the adhesive layer-equipped transparent plate and an object to be bonded are bonded in a reduced pressure atmosphere and then the laminate is returned to an atmospheric pressure atmosphere, shortening of the time required for the disappearance of voids formed at the interface between the adhesive layer and the object.

The content of the non-curable oligomer (III) in the first composition (100 mass %) is preferably from 10 to 70 mass %. When the content of the non-curable oligomer (III) is at least the lower limit value, voids are less likely to remain in the adhesive layer. When the content of the non-curable oligomer (III) is at most the upper limit value, the layer portion of the adhesive layer will sufficiently be cured. When the layer portion is sufficiently cured, it is easy to remove the protective film from the adhesive layer after curing.

Further, also a chain transfer agent contributes to shortening of the time until voids formed at the interface between the adhesive layer and an object to be bonded will disappear.

In a case where the first composition contains no chain transfer agent and contains the monomer (B1) and the monomer (B2) in a mass ratio of the monomer (B2) of from 0.6 to 2.5 to the monomer (B1), the content of the non-curable oligomer (III) in the first composition (100 mass %) is more preferably from 30 to 70 mass %, further preferably from 40 to 70 mass %. In a case where the first composition contains a chain transfer agent in an amount of at most 1 part by mass per 100 parts by mass of the curable compound (II), and the content of the monomer (B2) is less than the monomer (B1), the content of the non-curable oligomer (III) in the first composition (100 mass %) is preferably from 40 to 70 mass %, more preferably from 50 to 70 mass %.

In a case where the first composition contains the monomer (B1) and the monomer (B2) in a mass ratio of the monomer (B2) of from 1 to 3 to the monomer (B1) and contains a chain transfer agent in an amount of at most 1 part by mass per 100 parts by mass of the curable compound (II), the content of the non-curable oligomer (III) in the first composition (100 mass %) is more preferably from 5 to 55 mass %, further preferably from 10 to 50 mass %, particularly preferably from 35 to 50 mass %.

If the first composition contains the monomer (B2) or a chain transfer agent, the curing speed tends to be slow, and accordingly the amount of use of the monomer (B2) and the chain transfer agent is preferably small.

In a case where the mass ratio of the monomer (B2) is less than 0.6 to the monomer (B1) in the first composition, and the first composition contains no chain transfer agent, the content of the non-curable oligomer (III) in the first composition (100 mass %) is preferably from 40 to 70 mass %, more preferably from 50 to 70 mass %. (Photopolymerization initiator (D2))

The photopolymerization initiator (D2) may be a photopolymerization initiator of e.g. acetophenone type, ketal type, benzoin or benzoin ether type, phosphine oxide type, benzophenone type, thioxanthone type or quinone type. The photopolymerization initiator (D2) is preferably a photopolymerization initiator of phosphine oxide type or thioxanthone type, and with a view to preventing coloring after the photopolymerization reaction, particularly preferably a photopolymerization initiator of phosphine oxide type.

The content of the photopolymerization initiator (D2) in the photocurable first composition is preferably from 0.01 to 10 parts by mass, more preferably from 0.1 to 5 parts by mass per 100 parts by mass of the total amount of the oligomer (A), the monomer (B) and the monomer (C).

### (Additives)

As the additives to be added to the first composition, the same additives as mentioned for the second composition may be mentioned. The additives to be added to the first composition are preferably a polymerization inhibitor and a light stabilizer. Particularly, by a polymerization inhibitor in an amount smaller than the polymerization initiator being contained, the storage stability of the first composition can be improved, and the molecular weight of the layer portion after curing can be adjusted.

The content of the additives in the first composition is preferably at most 10 parts by mass, more preferably at most 5 parts by mass per 100 parts by mass of the total amount of the oligomer (A), the monomer (B) and the monomer (C).

When a chain transfer agent is contained in the first composition, the time until voids which are formed at the time of bonding the display panel and the adhesive layer-equipped transparent plate, will disappear, tends to be short. Accordingly, it becomes possible to reduce the amount of the non-curable oligomer (III) required to obtain the effect to let such voids disappear, by use of a chain transfer agent. If the amount of the non-curable oligomer (III) is small, the difference in the curing shrinkage between the seal portion and the layer portion tends to be small. In order to obtain a favorable curing speed, it is preferred that no chain transfer agent is contained, or it is contained only in a small amount.

In a case where a chain transfer agent is contained, its amount is preferably at most 1 part by mass, more preferably at most 0.5 part by mass, per 100 parts by mass of the total amount of the oligomer (A), the monomer (B) and the monomer (C).

The thickness of the layer portion 18 is preferably from 0.03 to 2 mm, more preferably from 0.1 to 0.8 mm. When the thickness of the layer portion 18 is at least the lower limit value, the layer portion 18 is capable of effectively damping an impact, etc. by external force from the transparent plate 10 side, thereby to protect the display panel. Further, in the process for producing a display device of the present invention, even if a foreign matter not exceeding the thickness of the layer portion 18 is included between the display panel and the adhesive layer-equipped transparent plate 1, the thickness of the layer portion 18 will not be substantially changed, and an influence over the optical transparency is little. When the thickness of the layer portion 18 is at most the upper limit value, voids are less likely to remain in the layer portion 18, and the entire thickness of the display device will not be thick more than necessary.

The value (Δ tan δ) obtained by subtracting the loss tangent at 25° C. (tan θ (25° C.)) from the loss tangent at 80° C. (tan θ (80° C.)) of the layer portion 18 is preferably at most −0.05. When the Δ tan δ is at most −0.05, favorable adhesive force with an object to be bonded will be obtained, and excellent reliability will be obtained.

The storage shear modulus at 35° C. of the layer portion 18 is preferably from 0.5 to 100 kPa. The lower limit value of the storage shear modulus of the layer portion 18 is more preferably 0.8 kPa. The upper limit value of the storage shear modulus of the layer portion 18 is more preferably 25 kPa, further preferably 12 kPa. When the storage shear modulus is at least 0.5 kPa, the shape of the layer portion 18 will easily be maintained. Further, even in a case where the layer portion 18 is relatively thick, the thickness can be maintained to be uniform over the entire layer portion 18, and at the time when the adhesive layer-equipped transparent plate 1 and an object to be bonded are bonded, voids are less likely to form at the interface between the adhesive layer 14 and the object. When the storage shear modulus is at most 100 kPa, voids formed at the time when the adhesive layer-equipped transparent plate 1 and an object to be bonded are bonded in a reduced pressure atmosphere and then the laminate is returned to an atmospheric pressure atmosphere, at the interface between the object and the adhesive layer 14 will disappear in short time and are less likely to remain. This is estimated to be because since the molecular mobility of the resin forming the layer portion is relatively high, at the time when the adhesive layer-equipped transparent plate 1 and the object to be bonded are bonded in a reduced pressure atmosphere and then the laminate is returned to an atmospheric pressure atmosphere, the volume of voids is likely to decrease by differential pressure between the pressure in the voids (the reduced pressure) and the pressure exerted to the layer portion (the atmospheric pressure).

To determine the storage shear modulus at 35° C. of the layer portion 18, using a rheometer (modular rheometer Physica MCR-301, manufactured by Anton Paar), a space between a measuring spindle and a light-transmitting plate is adjusted to be the same as the thickness of the layer portion, and the uncured first composition is disposed in the space, and while applying heat or light required for curing to the uncured first composition, the storage shear modulus during the curing process is measured, and the measured value under the curing condition at the time of forming the layer portion 18, is taken as the storage shear modulus of the layer portion 18.

In the present invention, it is preferred that the value (Δ tan δ) obtained by subtracting the loss tangent at 25° C. (tan θ (25° C.)) from the loss tangent at 80° C. (tan δ(80° C.)) of the layer portion is at most −0.05, and that the storage shear modulus at 35° C. is at most 100 kPa.

### <Protective Film>

The protective film 16 is required to be not firmly bonded to the adhesive layer 14 and to be able to be bonded to the supporting plate in the after-mentioned process of the present invention. Therefore, the protective film 16 is preferably a self-adhesive protective film such that one surface of a substrate film having a relatively low adhesion such as a polyethylene, a polypropylene or a fluorinated resin, is made to be an adhesive surface.

The adhesive force of the adhesive surface of the protective film 16 is preferably from 0.01 to 0.1N, more preferably from 0.02 to 0.06 N, by a test specimen with a width of 50 mm in a 180° peeling test at a peeling rate of 300 mm/min against an acrylic plate. When the adhesive force is at least the lower limit value, bonding to a supporting plate is possible. When the adhesive force is at most the upper limit value, it is easy to remove the protective film 16 from the supporting plate.

A preferred thickness of the protective film 16 may vary depending upon the resin to be used, but in a case where a relatively flexible film of e.g. polyethylene or polypropylene is to be used, the thickness is preferably from 0.04 to 0.2 mm, more preferably from 0.06 to 0.1 mm. When the thickness of the protective film 16 is at least the lower limit value, it is possible to prevent deformation of the protective film 16 at the time of removing the protective film 16 from the adhesive layer 14. When the thickness of the protective film 16 is at most the upper limit value, the protective film 16 is likely to be deflected at the time of removal, and can easily be removed from the adhesive layer 14.

Further, it is also possible to further facilitate removal from the adhesive layer 14 by providing a rear surface layer on the back surface opposite to the adhesive surface of the protective film 16. Also for such a rear surface layer, it is preferred to employ a film having relatively low adhesion made of e.g. a polyethylene, a polypropylene or a fluorinated resin. In order to further facilitate removal of the protective film 16, a release agent such as silicone may be applied to the protective film 16 within a range not to impair the adhesive layer 14.

### Other Embodiments

The illustrated adhesive layer-equipped transparent plate 1 is an example wherein the transparent plate is a protective plate for a display device. However, the adhesive layer-equipped transparent plate of the present invention is not limited to the illustrated one and may be any material so long as the specific adhesive layer is formed on at least one surface of the transparent plate.

For example, the adhesive layer-equipped transparent plate of the present invention may be one wherein the specific adhesive layer is formed on both surfaces of the transparent plate. Further, it may also be one wherein another transparent plate is bonded instead of the protective film, and the adhesive layer is sandwiched between a pair of transparent plates.

Further, the adhesive layer-equipped transparent plate of the present invention may be one wherein a polarizing means (such as a film-form absorption-type polarizer or a wire grid-type polarizer) or an optical modulator means (such as a phase difference film such as a ¼ retardation sheet, or a stripe-patterned phase difference film) is provided between the transparent plate (the protective plate) and the specific adhesive layer.

### <<Process for Producing Adhesive Layer-Equipped Transparent Plate>>

The process for producing the adhesive layer-equipped transparent plate of the present invention is a process comprising the following steps (a) to (e):

(a) a step of applying a liquid second composition to a peripheral portion of the surface of the transparent plate to form an uncured seal portion,

(b) a step of supplying a liquid first composition to a region surrounded by the uncured seal portion,

(c) a step of overlaying, in a reduced pressure atmosphere of at most 1 kPa, a protective film-bonded supporting plate on the first composition so that the protective film is in contact with the first composition, to obtain a laminate wherein an uncured layer portion made of the first composition, is sealed by the transparent plate, the protective film and the uncured seal portion made of the second composition,

(d) a step of curing the uncured layer portion and the uncured seal portion in a state where the laminate is held in an elevated pressure atmosphere of at least 50 kPa, to form an adhesive layer having a layer portion and a seal portion, and

(e) a step of removing the supporting plate from the protective film.

The process of the present invention is a process wherein in a reduced pressure atmosphere, the first composition is sealed in between the transparent plate and the protective film bonded to the supporting plate, and in a high pressure atmosphere such as an atmospheric pressure atmosphere, the sealed first composition is cured to form a layer portion. As a method of sealing the first composition under reduced pressure, not a method of injecting the first composition into a shallow wide space between the transparent plate and the protective film bonded to the supporting plate, but a method of supplying the first composition substantially over the entire surface of the transparent plate, and then, the protective film bonded to the supporting plate is overlaid to seal in the first composition between the transparent plate and the protective film bonded to the supporting plate, is employed.

An example of the method for producing a transparent laminate by sealing a curable resin composition under reduced pressure and curing the curable resin composition in an atmospheric pressure atmosphere, is known. For example, WO2008/81838 and WO2009/16943 disclose a process for producing such a transparent laminate and a curable resin composition to be used in such a process. In production of the adhesive layer-equipped transparent plate of the present invention, a production method disclosed in such documents may be employed.

Now, the process will be described in detail with reference to the process for producing an adhesive layer-equipped transparent plate 1 as shown in FIG. 1.

<Step (a)>

As shown in FIGS. 2 and 3, a liquid second composition is applied by a dispenser (not shown) or the like along a light-shielding printed portion 12 at the peripheral portion of a transparent plate 10 to form an uncured seal portion 20A.

Application of the second composition is carried out e.g. by a printing machine or a dispenser.

The seal portion may be in an uncured state or may be a semi-cured state where it is partially cured. Partial curing of the seal portion is carried out by light irradiation in a case where the second composition is a photocurable resin composition. For example, the photocurable resin composition is partially cured by irradiation with ultraviolet light or visible light with a short wavelength from a light source (such as an ultraviolet lamp, a high pressure mercury lamp or UV-LED).

<Step (b)>

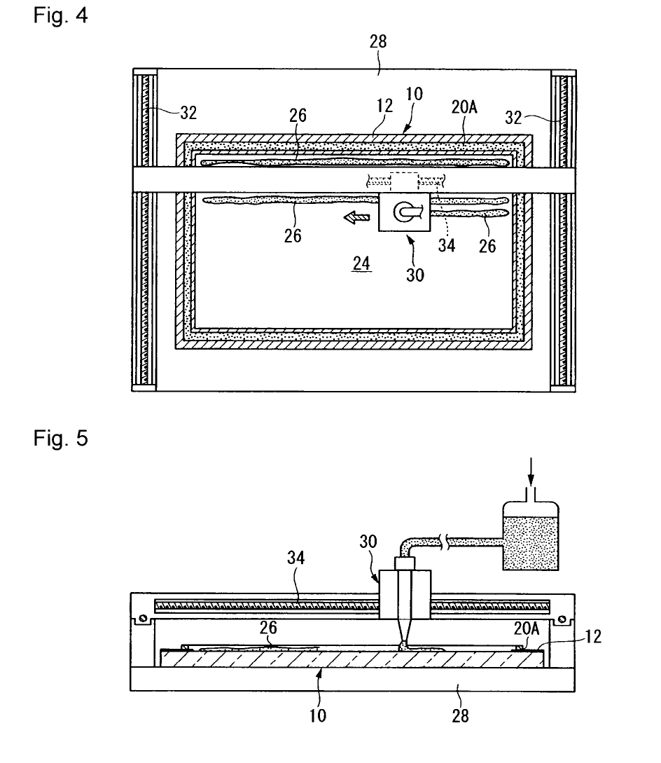

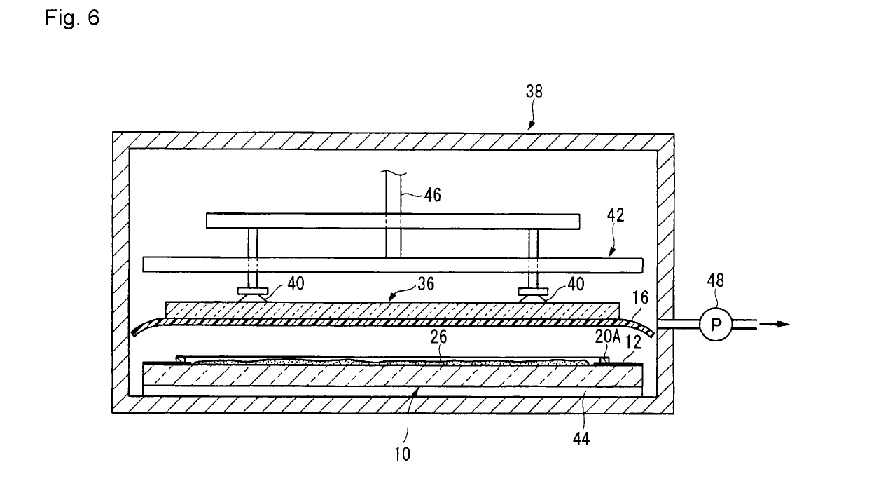

Then, as shown in FIGS. 4 and 5, a liquid first composition 26 is supplied to a rectangular region 24 surrounded by the uncured seal portion 20A on the transparent plate 10. The amount of the first composition 26 to be supplied, is preliminarily set to be an amount such that the space to be sealed by the seal portion 22, the transparent plate 10 and the protective film 16 (see FIG. 6), is filled by the first composition 26, and the distance between the transparent plate and the protective film is adjusted to be a prescribed distance (i.e. the layer portion is adjusted to have the prescribed thickness). At that time, it is desirable that a volume decrease due to the curing shrinkage of the first composition is taken into account. Accordingly, such an amount is preferably an amount such that the thickness of the first composition becomes slightly thicker than the prescribed thickness of the layer portion.

Supplying of the first composition 26 is carried out in such a manner that as shown in FIGS. 4 and 5, the transparent plate 10 is placed flatly on a lower platen 28, and by means of a horizontally moving dispenser 30, the first composition 26 is supplied in a dot, line or plane-form.

The dispenser 30 in this example is made to be horizontally movable in the entire range of the region 24 by a known horizontal movement mechanism comprising a pair of feed screws 32 and a feed screw 34 perpendicular to the feed screws 32.

<Step (c)>

Then, as shown in FIG. 6, the transparent plate 10 and the supporting plate 36 having the protective film 16 bonded thereto, are brought in a pressure reducing device 38. Bonding of the protective film 16 to the supporting plate 36 is carried out by bonding the protective film 16 which is supplied as a rolled material to the supporting plate 36 by means of e.g. a rubber roll. At that time, in order to avoid formation of voids between the supporting plate 36 and the adhesive surface of the protective film 16, the rubber roll may be pressed against the supporting plate 36, or the bonding may be carried out in a reduced pressure atmosphere. It is preferred to employ a protective film 16 slightly larger than the supporting plate 36, so that the ends of the protective film 16 can easily be gripped at the time of removal from the adhesive layer 14.

At an upper portion in the pressure reducing device 38, an upper platen 42 having a plurality of suction pads 40 is disposed, and at a lower portion, a lower platen 44 is provided. The upper platen 42 is made to be vertically movable by an air cylinder 46. The supporting plate 36 is attached to the suction pads 40 so that the surface having the protective film 16 bonded faces downward. The transparent plate 10 is fixed on the lower platen 44 so that the surface having the first composition 26 supplied faces upward. That is, the first composition 26 on the transparent plate 10 and the protective film 16 on the surface of the supporting plate 36 are permitted to face each other without being in contact with each other.

The supporting plate 36 is a transparent plate such as a glass plate or a resin plate. The thickness of the glass plate to be used as the supporting plate 36 is preferably from 0.5 to 10 mm, particularly preferably from 1.0 to 5.0 mm. When the thickness of the glass plate is at least the lower limit value, the supporting plate 36 is less likely to have warpage or deflection. When the thickness of the glass plate is at most the upper limit value, the mass of the supporting plate 36 will not be unnecessarily large, and the supporting plate 36 is less likely to be displaced at the time of moving the laminate before curing the adhesive layer 14.

After placing the transparent plate 10 and the supporting plate 36 at the predetermined positions, the air in the pressure reducing device 38 is suctioned by a vacuum pump 48 to evacuate the interior of the pressure reducing device 38 to form a predetermined reduced pressure atmosphere.

The reduced pressure atmosphere is at most 1 kPa, preferably from 10 to 100 Pa, more preferably from 15 to 40 Pa. When the reduced pressure atmosphere is at least the lower limit value, the respective components (such as a curable compound, a photopolymerization initiator, a polymerization inhibitor, a chain transfer agent, a light stabilizer, etc.) contained in the first composition are less likely to volatilize, and the time required until the reduced pressure atmosphere is achieved tends to be short.

After the atmosphere pressure in the pressure reducing device 38 has reached, for example, a reduced pressure atmosphere of from 15 to 40 Pa, the air cylinder 46 is operated to let the supporting plate 36 descend towards the transparent plate 10 waiting below, in such a state as suction-held by the suction pads 40 of the upper platen 42. And, the transparent plate 10 and the supporting plate 36 having the protective film 16 bonded thereto, are laminated via the uncured seal portion 20A to constitute a laminate wherein the uncured layer portion made of the first composition 26 is sealed by the transparent plate 10, the protective film 16 and the uncured seal portion 20A, and the laminate is maintained in a reduced pressure atmosphere for a predetermined period of time.

In the laminate, the first composition 26 is pressed and spread by the self weight of the supporting plate 36 and the pressing pressure from the movable support mechanism, etc., and the first composition 26 is filled in the above space to form an uncured layer portion.

The period of time from the time when the transparent plate 10 and the supporting plate 36 are laminated to the release of the reduced pressure atmosphere, is not particularly limited, and after sealing the first composition 26, the reduced pressure atmosphere may immediately be released, and after sealing the first composition 26, the reduced pressure state may be maintained for a predetermined period of time. By maintaining the reduced pressure state for a predetermined period of time, the first composition flows in the sealed space, whereby the distance between the transparent plate 10 and the protective film 16 bonded to the supporting plate 36 becomes uniform, and it becomes easy to maintain the sealed state even if the pressure of the atmosphere is increased.

The period of time to maintain the reduced pressure state may be a long time of at least a few hours, but from the viewpoint of the production efficiency, it is preferably within one hour, more preferably within 10 minutes.

In the production process of the present invention, in a case where a second composition having a high viscosity is applied to form an uncured seal portion 20A, the thickness of the first composition 26 in the laminate obtained in the step (c) can be made to be relatively thick at a level of from 0.03 to 2 mm.

<Step (d)>

After releasing the reduced pressure atmosphere in step (c), the laminate is held in an elevated pressure atmosphere of at least 50 kPa. For example, the inside of the pressure reducing device 38 is made to be e.g. an atmospheric pressure atmosphere, and then the laminate is taken out from the pressure reducing device 38.

When the laminate is held in an elevated pressure atmosphere of at least 50 kPa, by the elevated pressure, the transparent plate 10 and the supporting plate 36 are pressed in the direction for adhesion. Accordingly, even if voids are present in the sealed space in the laminate, an uncured layer portion will flow in the voids, and the entire sealed space will be uniformly filled with an uncured layer portion.

The elevated pressure atmosphere in the step (d) may be an atmospheric pressure atmosphere or an atmosphere under a higher pressure. The elevated pressure atmosphere in the step (d) is preferably from 80 to 120 kPa. Further, the elevated pressure atmosphere in the step (d) is most preferably an atmospheric pressure atmosphere in that an operation such as curing of the uncured layer portion can be carried out without requiring any special installation.

The period of time (hereinafter referred to as the high pressure retention time) from the time when the laminate is held under an elevated pressure atmosphere of at least 50 kPa to the initiation of curing of the uncured layer portion, is not particularly limited. In a case where a process of taking out the laminate from the pressure reducing device, transferring it to a curing device and initiating the curing, is carried out in an atmospheric pressure atmosphere, the time required for the process is the high pressure retention time. Therefore, in a case where at the time when the laminate is placed in an atmospheric air atmosphere, voids are no longer present in the sealed space of the laminate, or in a case where voids have disappeared during the process, the uncured layer portion can immediately be cured. In a case where it takes time until voids will disappear, the laminate is held in an atmosphere under a pressure of at least 50 kPa until voids will disappear. Further, even if the high retention time becomes long, usually, there will no trouble, and therefore, the high pressure retention time may be prolonged depending upon other necessities for the process. The high temperature retention time may be as long as more than one day, but from the viewpoint of the production efficiency it is preferably within 6 hours, more preferably within one hour, particularly preferably within 10 minutes, since the production efficiency will be higher.

Then, the uncured seal portion 20A and the uncured layer portion in the inside of the laminate are cured to form an adhesive layer 14 having a seal portion 20 and a layer portion 18.

Curing of the uncured seal portion may be carried out at the same time as curing of the uncured layer portion, or may preliminarily be carried out prior to curing of the uncured layer portion.

In a case where the uncured layer portion and the uncured seal portion 20A are made of photocurable compositions, they are cured by irradiation with light (e.g. ultraviolet light or visible light with a short wavelength) from the supporting plate 36 side. For example, from a light source (such as an ultraviolet lamp, a high pressure mercury lamp or UV-LED) ultraviolet light or visible light with a short wavelength is applied to cure the uncured layer portion and the uncured seal portion 20A.

The light is preferably ultraviolet light or visible light with a wavelength of at most 450 nm.

In a case where a light-shielding printed portion is formed along the peripheral portion of the transparent plate, or in a case where an antireflection layer is provided on the transparent plate, light is applied from the supporting plate side.

In a case where the layer portion 18 is made of a photocurable first composition and if sufficiently photo-cured, a suitable storage shear modulus will not be obtainable, application of light may be stopped during the curing, and after bonding to an object to be bonded (e.g. a display panel), the layer portion 18 may be irradiated again with light or heated to accelerate the curing of the layer portion 18. In a case where the curing is accelerated by heating, a very small amount of a thermal polymerization initiator may be incorporated to the photocurable first composition. Even in a case where a thermal polymerization initiator is not incorporated, by maintaining heating after an incomplete photocuring, the cured state of the layer portion 18 can be stabilized, such being preferred.

By employing photocurable first composition and second composition, the adhesive layer-equipped transparent plate can be produced at a low temperature at which a film is durable, such being advantageous from the viewpoint of the protection of the protective film.

<Step (e)>

The supporting plate 36 is removed from the protective film 36 to obtain an adhesive layer-equipped transparent plate 1 wherein an adhesive layer 14 having a sufficient adhesion is formed on a transparent plate 10, and formation of voids at the interface between the transparent plate 10 and the adhesive layer 14 is sufficiently prevented.

### <Advantageous Effects>

The adhesive layer-equipped transparent plate of the present invention is advantageous in that the layer portion has high flowability since it contains the non-curable oligomer (III), and even if voids remain in the layer portion sealed under reduced pressure at the time of production, the voids will disappear in a short period of time by the differential pressure between the pressure in the voids when returned to the atmospheric pressure atmosphere and the pressure exerted to the adhesive layer. Further, the adhesive layer-equipped transparent plate of the present invention is advantageous in that the layer portion has low elasticity since it contains the non-curable oligomer (III), and the stress exerted to the display panel bonded is small. Accordingly, when the adhesive layer-equipped transparent plate of the present invention is bonded to an object to be bonded, the stress exerted to the object is small.

Further, in the adhesive layer-equipped transparent plate of the present invention, the layer portion is partially crosslinked since the curable compound (II) constituting the first composition contains the monomer (C). By the layer portion being partially crosslinked, an increase in the flowability at the layer portion at high temperature is prevented. Accordingly, even when the adhesive layer-equipped transparent plate of the present invention is stored at high temperature in a state where it is bonded to an object to be bonded, sufficient adhesive force with the object will be maintained.

The high temperature environment in which the adhesive layer-equipped transparent plate of the present invention can be used is preferably from 50 to 130° C., more preferably from 60 to 100° C. Further, in a case where it is from 50 to 90° C., the adhesive force with an object to be bonded can be maintained for a long period of time of 500 hours or longer.

Further, in the adhesive layer-equipped transparent plate of the present invention, at least one member of the monomer (B) and the monomer (C) has a hydroxy group, such hydroxy groups remain in the layer portion, and the stability of the non-curable oligomer (III) in the layer portion is favorable.

The above-described adhesive layer-equipped transparent plate is suitable as a protective plate for a display device.

### <Display Device>

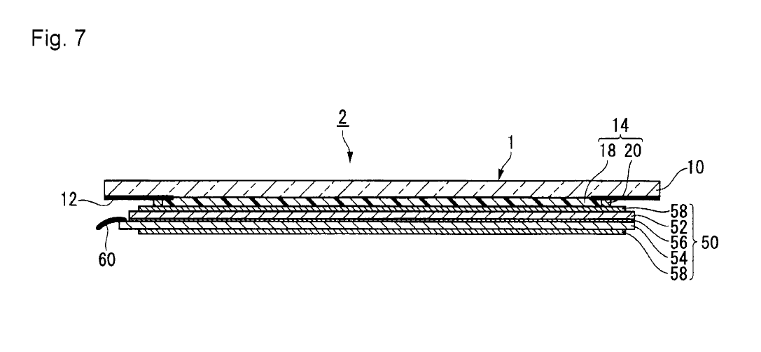

FIG. 7 is a cross-sectional view illustrating an example of the display device of the present invention.

The display device 2 comprises a display panel 50 and an adhesive layer-equipped transparent plate 1 bonded to the display panel 50 so that the adhesive layer 14 is in contact with the display panel 50, and a flexible printed circuit board 60 (FPC) connected to the display panel 50 and having a driving IC mounted which drives the display panel 50.

The illustrated display panel 50 is an example of a liquid crystal panel having a construction wherein a transparent substrate 52 provided with a color filter and a transparent substrate 54 provided with TFT (a thin film transistor) are bonded via a liquid crystal layer 56, and this assembly is sandwiched between a pair of polarizing plates 58. The display panel in the present invention is not limited to the illustrated one.

### <<Process for Producing Display Device>>

The process for producing a display device of the present invention is a process of laminating and bonding the display panel and the adhesive layer-equipped transparent plate of the present invention in a reduced pressure atmosphere of at most 100 Pa so that the adhesive layer is in contact with the display panel. In a case where the surface of the adhesive layer is covered with the protective film as in the case of the adhesive layer-equipped transparent plate 1, the display panel and the adhesive layer-equipped transparent plate are bonded after the protective film is removed.

The reduced pressure atmosphere at the time of bonding the display panel and the adhesive layer-equipped transparent plate are bonded is at most 100 Pa, preferably from 1 to 100 Pa, more preferably from 5 to 50 Pa.

### EXAMPLES

Now, the present invention will be described with reference to Examples, but it should be understood that the present invention is by no means restricted to such Examples.

### [Transparent Plate]

Along the peripheral portion of one surface of soda lime glass having a length of 100 mm, a width of 100 mm and a thickness of 1.3 mm, a light-shielding printed portion was formed in a frame-form by ceramic printing containing a black pigment, so that a light-transmitting portion would have a length of 68 mm and a width of 68 mm, thereby to prepare a transparent plate i.

### [Supporting Plate)

Soda lime glass having a length of 100 mm, a width of 100 mm and a thickness of 1.1 mm was used as a supporting plate ii.

### [Bonding of Protective Film to Supporting Plate]

On one side of the supporting plate, a protective film (Puretect VLH-9, manufactured by Tohcello Co., Ltd.) having a length of 130 mm, a width of 130 mm and a thickness of 0.75 mm was bonded so that the adhesive surface of the protective film was in contact with the glass, by means of a rubber roll, to prepare a supporting plate ii having the protective film bonded thereto.

### [Object to be Bonded]

As an object to be bonded, an adhesive layer-equipped polarizing plate (KN-18240T, manufactured by Polatechno Co., Ltd.) was bonded to one side of soda lime glass having a length of 90 mm, a width of 90 mm and a thickness of 1.7 mm, to prepare a plate to be bonded iii which replaces a liquid crystal display panel.

### Example 1

### Layer Portion-Forming Photocurable Resin Composition

### First Composition

A bifunctional polypropylene glycol having molecular terminals modified by ethylene oxide (Mn calculated by the hydroxy value: 4,000) and 3-isocyanatomethyl-3,5,5-trimethylcyclohexyl diisocyanate were mixed in a molar ratio of 4:5 and reacted at 70° C. in the presence of a tin catalyst to obtain an isocyanate-terminated prepolymer. To the obtained prepolymer, 2-hydroxyethyl acrylate was added in an amount equivalent to isocyanate groups and reacted at 70° C. to obtain an urethane acrylate oligomer (A-1) (hereinafter referred to as “oligomer (A-1)”). The number of curable functional groups in the oligomer (A-1) was 2, Mn was about 24,000, and the viscosity at 25° C. was about 830 Pa·s.

40 Parts by mass of the oligomer (A-1), 30 parts by mass of 2-hydroxybutyl methacrylate (Light Ester HOB (N), manufactured by KYOEISHA CHEMICAL CO., LTD.) as the monomer (B1) and 30 parts by mass of n-dodecyl methacrylate as the monomer (B2) were uniformly mixed to obtain a composition P. Then, in 100 parts by mass of the composition P, 0.3 part by mass of a photopolymerization initiator (IRGACURE 819, manufactured by Ciba Specialty Chemicals K.K.), 0.04 part by mass of 2,5-di-tert-butylhydroquinone (polymerization inhibitor, manufactured by TOKYO CHEMICAL INDUSTRY CO., LTD.), 0.3 part by mass of an UV absorber (Tinuvin 109, manufactured by BASF) and 0.5 part by mass of n-dodecyl mercaptan (chain transfer agent, THIOKALCOL 20, manufactured by KAO Corporation) were uniformly dissolved to obtain a composition P-1.

70 Parts by mass of the composition P-1 and 30 parts by mass of a non-curable oligomer (III-i) were uniformly dissolved to obtain a liquid first composition 1.

As the non-curable oligomer (III-i), the bifunctional polypropylene glycol having molecular terminals modified by ethylene oxide (Mn calculated by the hydroxy value: 4,000), which is the same as one used for preparation of the oligomer (A-1), was used.

The first composition 1 was set in a pressure reducing device, as it was put in a container in an open state, and the inside of the pressure reducing device was evacuated to about 20 Pa and maintained for 20 minutes to carry out degassing treatment.

### (Seal Portion-Forming Photocurable Resin Composition: Second Composition)

A bifunctional polypropylene glycol having molecular terminals modified by ethylene oxide (Mn calculated by the hydroxy value: 4,000) and hexamethylene diisocyanate were mixed in a molar ratio of 6:7, and then isobornyl acrylate (IBXA, manufactured by OSAKA ORGANIC CHEMICAL INDUSTRY LTD.) was added in an amount of 30 mass % based on the oligomer, followed by reaction at 70° C. in the presence of a tin catalyst to obtain an isocyanate-terminated prepolymer. To the obtained prepolymer, 2-hydroxyethyl acrylate was added in an amount equivalent to isocyanate groups and reacted at 70° C. to obtain an urethane acrylate oligomer (X-1) (hereinafter referred to as “oligomer (X-1)”) diluted with 30 mass % of isobornyl acrylate. The oligomer (X-1) had 2 urethane acrylate groups and one isobornyl acrylate groups as the curable functional groups, Mn was about 55,000, and the viscosity at 60° C. was about 580 Pa·s.

90 Parts by mass of the oligomer (X-1) and 10 parts by mass of 2-hydroxybutyl methacrylate (Light Ester HOB(N)), manufactured by KYOEISHA CHEMICAL CO., LTD.) were uniformly mixed to obtain a mixture. 100 Parts by mass of the mixture, 0.9 part by mass of 1-hydroxy-cyclohexyl-phenyl-ketone (photopolymerization initiator, IRGACURE 184, manufactured by Ciba Specialty Chemicals K.K.) and 0.1 part by mass of bis(2,4,6-trimethylbenzoyl)-phenylphosphine oxide (photopolymerization initiator, IRGACURE 819, manufactured by Ciba Specialty Chemicals K.K.) were uniformly mixed to obtain a liquid second composition 1.

### (Step (a))

Over the entire periphery at a portion of about 5 mm from the inner edge of the light shielding printed portion of the transparent plate i, the liquid second composition 1 was applied by a dispenser so that the width would be about 1 mm and the applied thickness would be about 0.6 mm, to form an uncured seal portion.

Then, ultraviolet light and visible light of at most 450 nm from a chemical lamp (FL15BL, manufactured by NEC Corporation, peak wavelength: 365 nm, irradiation intensity: 2 mW/cm²) were uniformly applied for 30 seconds to the seal portion formed on the transparent plate i. The viscosity of the seal portion was thereby increased.

### (Step (b))

To a region inside of the seal portion formed on the transparent plate i, the liquid first composition 1 was supplied at plural portions so that the total mass would be 2.5 g by means of a disperser.

During the period for supplying the first composition 1, the shape of the seal portion was maintained.

### (Step (c))

On a lower platen in a pressure reducing device wherein a lifting and lowering device comprising a pair of platens was installed, the transparent plate i was flatly placed so that the surface of the first composition 1 faced upward.

By means of electrostatic chucks, the supporting plate ii having the protective film bonded thereto was held by the lower surface of the upper platen of the lifting and lowering device in the pressure reducing device, so that the distance from the transparent plate i would be 10 mm in a vertical direction.

The pressure reducing device was made to be in a sealed state and evacuated until the pressure in the pressure reducing device became about 40 Pa. By the lifting and lowering device in the pressure reducing device, the upper and lower platens were brought to be close to each other, and the transparent plate i and the supporting plate ii having the protective film bonded thereto, were pressed under a pressure of 2 kPa via the first composition 1 and maintained for 10 seconds. The electrostatic chucks were switched off, and the supporting plate ii was released from the upper platen, and in about 15 seconds, inside of the pressure reducing device was returned to an atmospheric pressure atmosphere to obtain a laminate 1 wherein a layer portion made of the first composition 1 was sealed by the transparent plate i, the protective film and the seal portion.

In the laminate 1, the shape of the seal portion was maintained to be substantially the same as the initial state, without breakage such as collapse.

### (Step (d))

To the uncured seal portion and the uncured layer portion of the laminate 1, from the supporting plate ii side, ultraviolet light and visible light of at most 450 nm from a chemical lamp (FL15BL, manufactured by NEC Corporation, peak wavelength: 365 nm, irradiation intensity: 2 mW/cm²) were uniformly applied for 10 minutes to cure the seal portion and the layer portion to form an adhesive layer.

The irradiation intensity was measured by means of an illuminometer (ultraviolet intensity meter Unimeter UIT-101, manufactured by USHIO INC.)

The thickness of the layer portion after curing was 0.4 mm and was substantially uniform.

### (Step (e))

The supporting plate ii was removed from the protective film to obtain an adhesive layer-equipped transparent plate 1 having the protective film bonded thereto.

(Lamination with Object to be Bonded)

After removing the supporting plate ii from the protective film in the step (e), the adhesive layer-equipped transparent plate 1 was left at rest for 24 hours. Then, the protective film was removed from the adhesive layer on the transparent plate i, and the adhesive layer-equipped transparent plate 1 having the protective film removed, was flatly placed on a lower platen in a pressure reducing device wherein a lifting and lowering device comprising a pair of platens was installed, so that the surface of the adhesive layer faced upward.

By means of electrostatic chucks, the plate to be bonded iii was held by the lower surface of the upper platen in the lifting and lowering device in the pressure reducing device, so that the distance from the adhesive layer-equipped transparent plate 1 became 10 mm.

The pressure reducing device was made to be in a sealed state and evacuated until the pressure in the pressure reducing device became about 30 Pa. By the lifting and lowering device in the pressure reducing device, the upper and lower platens were brought to be close to each other, and the plate to be bonded iii and the adhesive layer-equipped transparent plate 1 were pressed under a pressure of 2 kPa via the adhesive layer and held for 10 seconds. The electrostatic chucks were switched off, and the plate to be bonded iii was removed from the upper platen, and in about 20 seconds, inside of the pressure reducing device was returned to an atmospheric pressure to obtain a laminate product 1.

### Examples 2 to 7

Compositions P-2 to 7 were prepared in the same manner as in Examples 1 except that 100 parts by mass of a composition having the composition P and 1,9-nonanediol dimethacrylate (1,9-ND, manufactured by KYOEISHA CHEMICAL CO., LTD., Mn: 268, monomer (C-1)) as the monomer (C) kneaded in a mixing ratio as identified in Table 1, was used instead of 100 parts by mass of the composition P. Further, laminate products 2 to 7 were obtained in the same manner as in Example 1 except that first compositions 2 to 7 in Examples 2 to 7 prepared in the same manner as in Example 1 using the compositions P-2 to 7 instead of the composition P-1, were used.

In Table 1 are shown the proportions of the composition P and the monomer (C-1) per 100 mass % of the total amount of the composition P and the monomer (C-1), and the addition amounts (parts by mass) of the polymerization initiator, the polymerization inhibitor, the UV absorber and the chain transfer agent per 100 parts by mass of the total amount of the composition P and the monomer (C-1). The same applies to Tables 3 and 5.

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| First composition | | | 1 | 2 | 3 | 4 | 5 | 6 | 7 |
| Non-curable | Content (parts by mass) | | 30 | 30 | 30 | 30 | 30 | 30 | 30 |
| oligomer | | | | | | | | | |
| (III-i) | | | | | | | | | |
| Composition | Type | | P-1 | P-2 | P-3 | P-4 | P-5 | P-6 | P-7 |
| | Content (parts by mass) | | 70 | 70 | 70 | 70 | 70 | 70 | 70 |
| | Composition | Composition P | 100 | 99.95 | 99.9 | 99.7 | 99 | 98 | 90 |
| | | (mass %) | | | | | | | |
| | | Monomer (C-1) | 0 | 0.05 | 0.1 | 0.3 | 1 | 2 | 10 |
| | | (mass %) | | | | | | | |
| | | Polymerization initiator | 0.3 | 0.3 | 0.3 | 0.3 | 0.3 | 0.3 | 0.3 |
| | | (parts by mass) | | | | | | | |
| | | Polymerization inhibitor | 0.04 | 0.04 | 0.04 | 0.04 | 0.04 | 0.04 | 0.04 |
| | | (parts by mass) | | | | | | | |
| | | UV absorber | 0.3 | 0.3 | 0.3 | 0.3 | 0.3 | 0.3 | 0.3 |
| | | (parts by mass) | | | | | | | |
| | | Chain transfer agent | 0.5 | 0.5 | 0.5 | 0.5 | 0.5 | 0.5 | 0.5 |
| | | (parts by mass) | | | | | | | |

### [Evaluation of Formation/Disappearance of Voids]

Voids (air bubbles) at the interface between the adhesive layer of the adhesive layer-equipped transparent plate 1 and the plate to be bonded iii were observed from immediately after production of the laminate product 1 until the laminate product 1 was left at rest for 24 hours, and an evaluation was made based on the standards ∘: voids disappeared within 6 hours, Δ: voids disappeared within 24 hours, and x: voids remained even after 24 hours. The results are summarized in Table 2.

### [Resin Viscoelasticity Evaluation (Storage Shear Modulus and Loss Tangent)]

Using a rheometer (Physica MCR301, manufactured by Anton Paar), the first composition was sandwiched in a space of 0.4 mm between a stage made of soda lime glass and a measuring spindle (D-PP20/AL/S07, manufactured by Anton Paar). In a nitrogen atmosphere, the first composition was irradiated with light of 2 mW/cm² for 10 minutes from a black light (FL15BL, manufactured by NEC Corporation) disposed below the stage at 35° C. Changes of the storage shear modulus (G′) and its loss tangent (tan δ) of the layer portion of the adhesive layer in the curing process were measured while applying 1% of dynamic shear strain.

Further, while 0.015% of dynamic shear strain was applied to the obtained layer portion (cured product of the first composition), the temperature was raised from 25° C. to 80° C. at a rate of 3° C./min, and the storage shear modulus (G′) and its loss tangent (tan δ) at the respective temperature regions were measured.

Further, as the index to the flowability of the adhesive layer in high temperature environment, the value obtained by subtracting tan δ at 25° C. from tan θ at 80° C. was calculated as Δ tan δ. The resin forming the layer portion had a glass transition point (Tg) in a temperature region of from −60° C. to −30° C., and was in a rubber state in room temperature region and was in a flowable state in a high temperature region.

### [Haze Measurement]

Using direct reading haze computer (HMG-2, manufactured by Suga Test Instruments Co., Ltd.), the haze at the central light-transmitting portion of the laminate product 1 was measured.

### [Reliability]

Several pieces of glass substrate (90 mm square, five pieces consisting of four pieces with a thickness of 2 mm and one piece with a thickness of 3 mm) corresponding to a load of about 200 g were fixed, by a heat resistance polyimide tape, to a rear side from the surface bonded to the adhesive layer-equipped transparent plate 1 of the plate to be bonded iii in the laminate obtained in each Example. In such a state, the laminate was stored for 500 hours in a thermo-hygrostat at a temperature of 60° C. under a humidity of 90% in a state where the laminated surface was vertically disposed. 500 Hours later, an evaluation was made based on standards ∘: the plate to be bonded iii maintained the same bonding position before the reliability test, and x voids were formed at the interface between the adhesive layer-equipped transparent plate and the plate to be bonded iii, displacement or separation of the plate to be bonded iii and the load glass occurred at the interface with the adhesive layer-equipped transparent plate. The results are summarized in Table 2.

The measurement results and the evaluation results are shown in Table 2.

TABLE 2

| | | Ex. 1 | Ex. 2 | Ex. 3 | Ex. 4 | Ex. 5 | Ex. 6 | Ex. 7 |
|---|---|---|---|---|---|---|---|---|
| First composition | | 1 | 2 | 3 | 4 | 5 | 6 | 7 |
| Layer | G′ [kPa] | 18 | 18 | 20 | 23 | 33 | 75 | 533 |
| portion | Δtanδ | 0.14 | 0.04 | −0.02 | −0.09 | −0.17 | −0.19 | −0.24 |
| Evalu- | Type | 1 | 2 | 3 | 4 | 5 | 6 | 7 |
| ation of | Disap- | ∘ | ∘ | ∘ | ∘ | ∘ | ∘ | x |
| lami- | pearance | | | | | | | |
| nate | of voids | | | | | | | |
| | Haze [%] | 0.30 | 0.30 | 0.30 | 0.40 | 0.40 | 0.60 | 1.70 |
| | Reliability | x | x | x | ∘ | ∘ | ∘ | ND |

As shown in Table 2, in Examples 1 to 3 in which the proportion of the monomer (C) is from 0 to 0.1 mass % to the total amount (100 mass %) of the oligomer (A), the monomer (B) and the monomer (C), displacement or separation of the object to be bonded occurred at the adhesive layer surface of the adhesive layer-equipped transparent plate.

In Examples 4 to 6 in which the proportion of the monomer (C) is from 0.3 to 2.0 mass %, the storage shear modulus of the resin after curing was within the above-described preferred range, voids quickly disappeared after lamination with the object to be bonded, and the laminate with the object to be bonded also had no problems such as formation of voids, displacement and separation after the reliability test, and had high reliability.

As the proportion of the monomer (C) increased, the storage shear modulus of the layer portion after curing tended to increase, and Δ tan δ changed from a positive value to a negative value. By an increase in the storage shear modulus, the time required until disappearance of voids formed in the laminate of the adhesive layer-equipped transparent plate and the plate to be bonded iii tended to be long, and in Example 7 in which the proportion of the monomer (C) is 10 mass %, the voids remained even 24 hours after lamination. Further, from the viewpoint of the solubility of the first composition in the oligomer (A-1), it was confirmed that as the proportion of the monomer (C) increased, the polymerization phase separation proceeded at the time of curing, and the transparency of the cured product obtained after curing decreased. Specifically, as the proportion of the monomer (C) increased, the haze of the laminate product increased, and in Example 7 in which the proportion of the monomer (C) was 10 mass %, the haze was 1.7%, thus indicating adverse effect to the appearance of the liquid crystal display as the object to be bonded.

### Examples 8 to 13

Compositions P-8 to 13 were prepared in the same manner as in Example 1 except that 100 parts by mass of a composition having the composition P and ethoxylated (3) trimethoxylolpropane triacrylate (SR454, manufactured by Sartomer, Mn: 428.4, monomer (C-2)) as the monomer (C) kneaded in a mixing ratio as identified in Table 3 was used instead of 100 parts by mass of the composition P. Further, laminate products 8 to 13 were obtained in the same manner as in Example 1 except that first compositions 8 to 13 prepared in the same manner as in Example 1 using compositions P-8 to 13 instead of the composition P-1, were used.

The measurement results and the evaluation results are shown in Table 4.

TABLE 3

| | | | Ex. 8 | Ex. 9 | E. 10 | Ex. 11 | Ex. 12 | Ex. 13 |
|---|---|---|---|---|---|---|---|---|
| First composition | | | 8 | 9 | 10 | 11 | 12 | 13 |
| Non-curable | Content (parts by mass) | | 30 | 30 | 30 | 30 | 30 | 30 |
| oligomer | | | | | | | | |
| (III-i) | | | | | | | | |
| Composition | Type | | P-8 | P-9 | P-10 | P-11 | P-12 | P-13 |
| | Content (parts by mass) | | 70 | 70 | 70 | 70 | 70 | 70 |
| | Composition | Composition P | 99.95 | 99.9 | 99.7 | 99 | 98 | 90 |
| | | (mass %) | | | | | | |
| | | Monomer (C-2) | 0.05 | 0.1 | 0.3 | 1 | 2 | 10 |
| | | (mass %) | | | | | | |
| | | Polymerization initiator | 0.3 | 0.3 | 0.3 | 0.3 | 0.3 | 0.3 |
| | | (parts by mass) | | | | | | |
| | | Polymerization inhibitor | 0.04 | 0.04 | 0.04 | 0.04 | 0.04 | 0.04 |
| | | (parts by mass) | | | | | | |
| | | UV absorber | 0.3 | 0.3 | 0.3 | 0.3 | 0.3 | 0.3 |
| | | (parts by mass) | | | | | | |
| | | Chain transfer agent | 0.5 | 0.5 | 0.5 | 0.5 | 0.5 | 0.5 |
| | | (parts by mass) | | | | | | |

TABLE 4

| | | Ex. 8 | Ex. 9 | Ex. 10 | Ex. 11 | Ex. 12 | Ex. 13 |
|---|---|---|---|---|---|---|---|
| First composition | | 8 | 9 | 10 | 11 | 12 | 13 |
| Layer | G′ [kPa] | 20 | 23 | 25 | 31 | 78 | 511 |
| portion | Δtanδ | 0.14 | 0.02 | −0.05 | −0.1 | −0.12 | −0.15 |
| Evalu- | Type | 8 | 9 | 10 | 11 | 12 | 13 |
| ation of | Disap- | ∘ | ∘ | ∘ | ∘ | ∘ | x |
| lami- | pearance | | | | | | |
| nate | of voids | | | | | | |
| | Haze [%] | 0.30 | 0.30 | 0.30 | 0.40 | 0.40 | 0.60 |
| | Reliability | x | x | ∘ | ∘ | ∘ | ND |

As shown in Table 4, in Examples 8 and 9 in which the proportion of the monomer (C) is at most 0.1 mass % to the total amount (100 mass %) of the oligomer (A), the monomer (B) and the monomer (C), displacement or separation of the object to be bonded occurred at the adhesive layer surface of the adhesive layer-equipped transparent plate.

In Examples 10 to 12 in which the proportion of the monomer (C) is from 0.3 to 2.0 mass %, the storage shear modulus of the resin after curing was within the above-described preferred range, voids quickly disappeared after lamination with the object to be bonded, and the laminate with a liquid crystal display device as the object to be bonded also had no problems such as formation of voids, displacement and separation after the reliability test, and had high reliability.

As the proportion of the monomer (C) increased, the storage shear modulus of the layer portion after curing tended to increase, and the time required until disappearance of voids formed in the laminate of the adhesive layer-equipped transparent plate and the plate to be bonded iii tended to be long, and in Example 13 in which the proportion of the monomer (C) is 10 mass %, the voids remained even 24 hours after lamination.

### Examples 14 to 17

Compositions P-14 to 17 were prepared in the same manner as in Example 1 except that 100 parts by mass of a composition having the composition P and a diacrylate compound of polytetramethylene glycol (A-PTMG-65, manufactured by Shin-Nakamura Chemical Co., Ltd., Mn: 758, monomer (C-3)) as the monomer (C) kneaded in a mixing ratio as identified in Table 5 was used instead of 100 parts by mass of the composition P. Further, laminate products 14 to 17 were obtained in the same manner as in Example 1 except that first compositions 14 to 17 prepared in the same manner as in Examples 1 using the compositions P-14 to 17 instead of the composition P-1, were used.

The measurement results and evaluation results are shown in Table 6.

TABLE 5

| | | | Ex. 14 | Ex. 15 | E. 16 | Ex. 17 |
|---|---|---|---|---|---|---|
| First composition | | | 14 | 15 | 16 | 17 |
| Non-curable | Content (parts by mass) | | 70 | 70 | 70 | 70 |
| oligomer | | | | | | |
| (III-i) | | | | | | |
| Composition | Type | | P-14 | P-15 | P-16 | P-17 |
| | Content (parts by mass) | | 30 | 30 | 30 | 30 |
| | Composition | Composition P | 99.5 | 99.9 | 98 | 90 |
| | | (mass %) | | | | |
| | | Monomer (C-3) | 0.5 | 0.1 | 2 | 10 |
| | | (mass %) | | | | |
| | | Polymerization | 0.3 | 0.3 | 0.3 | 0.3 |
| | | initiator | | | | |
| | | (parts by mass) | | | | |
| | | Polymerization | 0.04 | 0.04 | 0.04 | 0.04 |
| | | inhibitor | | | | |
| | | (parts by mass) | | | | |
| | | UV absorber | 0.3 | 0.3 | 0.3 | 0.3 |
| | | (parts by mass) | | | | |
| | | Chain transfer | 0.5 | 0.5 | 0.5 | 0.5 |
| | | agent | | | | |
| | | (parts by mass) | | | | |

TABLE 6

| | | Ex. 14 | Ex. 15 | Ex. 16 | Ex. 17 |
|---|---|---|---|---|---|
| First composition | | 14 | 15 | 16 | 17 |
| Layer | G′ [kPa] | 19 | 20 | 23 | 110 |
| portion | Δtanδ | 0.08 | 0.02 | −0.06 | −0.08 |
| Evaluation | Type | 14 | 15 | 16 | 17 |
| of | Disappearance | ∘ | ∘ | ∘ | Δ |
| laminate | of voids | | | | |
| | Haze [%] | 0.30 | 0.30 | 0.30 | 0.40 |
| | Reliability | x | x | ∘ | ∘ |

As shown in Table 6, in Examples 14 and 15 in which the proportion of the monomer (C) is at most 0.1 mass % to the total amount (100 mass %) of the oligomer (A), the monomer (B) and the monomer (C), displacement or separation of the object to be bonded occurred at the adhesive layer surface of the adhesive layer-equipped transparent plate.

In Example 16 in which the proportion of the monomer (C) is from 2.0 to 10.0 mass %, voids quickly disappeared after lamination with the object to be bonded, and the laminate with a liquid crystal display device as the object to be bonded also had no problems such as formation of voids, displacement and separation after the reliability test, and had high reliability. In Example 17, the storage shear modulus of the resin after curing was too high, and it took long until disappearance of the voids. The laminate with a display had no problem as in Example 16. The monomer (C-3) in the first composition used in Examples 14 to 17 had a high molecular weight as compared with the monomers (C-1) and (C-2) used in Examples 2 to 7 and 8 to 13, and thereby has a small number of curable groups in the resin composition in the case of comparison with the same addition amount, and as a result, the amount of addition of the monomer (C-3) required to suppress flowability of the adhesive layer is large. Further, by the monomer (C-3) having a relatively flexible structure of a polyoxyalkylene and having a high solubility in the oligomer (A-1) in the first composition, the storage shear modulus of the layer portion after curing was within a preferred range and the adhesive layer had favorable transparency even in a system in which the amount of addition of the monomer (C-3) was large.

### REFERENCE SYMBOLS

1: Adhesive layer-equipped transparent plate
2: Display device
10: Transparent plate
14: Adhesive layer
16: Protective film
18: Layer portion
20: Seal portion
24: Region
26: First composition
36: Supporting plate
50: Display panel

The entire disclosure of Japanese Patent Application No. 2012-279440 filed on Dec. 21, 2012 including specification, claims, drawings and summary is incorporated herein by reference in its entirety.

What is claimed is:

1. An adhesive layer-equipped transparent plate comprising a transparent plate and an adhesive layer formed on at least one surface of the transparent plate, wherein the adhesive layer has a layer portion spreading over the surface of the transparent plate and a seal portion surrounding the periphery of the layer portion; and the layer portion is made of a cured product of a layer portion-forming curable resin composition comprising the following curable compound (II) and the following non-curable oligomer (III):
curable compound (II): a compound containing a urethane acrylate oligomer (A), a monomer (B) having one curable functional group and having a molecular weight less than 600, and a monomer (C) having at least two curable functional groups and having a molecular weight less than 900, provided that at least one member of the monomer (B) and the monomer (C) has a hydroxy group;
non-curable oligomer (III): an oligomer which does not undergo a curing reaction with the curable compound (II) at the time of curing the layer portion-forming curable resin composition and which has a hydroxy group.

2. The adhesive layer-equipped transparent plate according to claim 1, wherein the monomer (C) has an acryloyloxy group or a methacryloyloxy group.

3. The adhesive layer-equipped transparent plate according to claim 1, wherein the curable compound (II) has a composition comprising from 20 to 89 mass % of the urethane acrylate oligomer (A), from 10 to 79 mass % of the monomer (B) and from 0.1 to 10 mass % of the monomer (C) per 100 mass % of the total amount of the urethane acrylate oligomer (A), the monomer (B) and the monomer (C).

4. The adhesive layer-equipped transparent plate according to claim 1, wherein the monomer (B) contains a monomer (B1) which has a hydroxy group.

5. The adhesive layer-equipped transparent plate according to claim 4, wherein the monomer (B1) contains a hydroxy methacrylate which has a C₃₋₈ hydroxyalkyl group having from 1 to 2 hydroxy groups.

6. The adhesive layer-equipped transparent plate according to claim 1, wherein the urethane acrylate oligomer (A) has a number average molecular weight of from 1,000 to 100,000.

7. The adhesive layer-equipped transparent plate according to claim 1, wherein the non-curable oligomer (III) is a polyoxyalkylene polyol, and the urethane acrylate oligomer (A) is a urethane acrylate oligomer prepared from a polyoxyalkylene polyol and a polyisocyanate as raw materials.

8. The adhesive layer-equipped transparent plate according to claim 1, wherein of the layer portion, the value obtained by subtracting the loss tangent at 25° C. (tan δ (25° C.)) from the loss tangent at 80° C. (tan δ (80° C.)) is at most −0.05, and the storage shear modulus at 35° C. is at most 100 kPa.

9. The adhesive layer-equipped transparent plate according to claim 1, wherein the layer portion-forming curable resin composition does not contain a chain transfer agent, or contains a chain transfer agent in an amount of at most 1 part by mass per 100 parts by mass of the curable compound (II).

10. The adhesive layer-equipped transparent plate according to claim 1, wherein the layer portion-forming curable resin composition contains a photopolymerization initiator (D2).

11. The adhesive layer-equipped transparent plate according to claim 1, wherein the transparent plate is a protective plate for a display device.

12. The adhesive layer-equipped transparent plate according to claim 1, which further has a removable protective film covering the surface of the adhesive layer.

13. A process for producing the adhesive layer-equipped transparent plate as defined in claim 12, which comprises the following steps (a) to (e):
(a) a step of applying a liquid seal portion-forming curable resin composition to a peripheral portion of the surface of the transparent plate to form an uncured seal portion,
(b) a step of supplying a liquid layer portion-forming curable resin composition to a region surrounded by the uncured seal portion,
(c) a step of overlaying, in a reduced pressure atmosphere of at most 1 kPa, a protective film-bonded supporting plate on the layer portion-forming curable resin composition so that the protective film is in contact with the layer portion-forming curable resin composition, to obtain a laminate wherein an uncured layer portion made of the layer portion-forming curable resin composition, is sealed by the transparent plate, the protective film and the uncured seal portion,
(d) a step of curing the uncured layer portion and the uncured seal portion in a state where the laminate is held in an elevated pressure atmosphere of at least 50 kPa, to form an adhesive layer having a layer portion and a seal portion, and
(e) a step of removing the supporting plate from the protective film.

14. A display device comprising a display panel and the adhesive layer-equipped transparent plate as defined in claim 1, bonded to the display panel so that the adhesive layer is in contact with the display panel.

15. A process for producing the display device as defined in claim 14, which comprises laminating and bonding, in a reduced pressure atmosphere of at most 100 Pa, the display panel and the adhesive layer-equipped transparent plate so that the adhesive layer is in contact with the display panel.
